(19) United States
(12) Patent Application Publication
(10) Pub. No.: US 2025/0289994 A1
(43) Pub. Date: Sep. 18, 2025

(54) METHODS FOR IMPROVING HYDROCARBON PRODUCTION FROM A SUBTERRANEAN FORMATION

(71) Applicant: CHEVRON U.S.A. INC., San Ramon, CA (US)

(72) Inventors: Varadarajan DWARAKANATH, Houston, TX (US); Guo-Qing TANG, Mountain View, CA (US); Gayani W. PINNAWALA, Katy, TX (US); Mohamad SALMAN, Midland, TX (US); David Enrique TORRES LOPEZ, Houston, TX (US); Dennis Arun ALEXIS, Richmond, TX (US); Gregory Arthur WINSLOW, Houston, TX (US); Hussein ALBOUDWAREJ, San Ramon, CA (US); Johannes Cornelis VISSER, Katy, TX (US)

(21) Appl. No.: 19/083,135

(22) Filed: Mar. 18, 2025

Related U.S. Application Data
(60) Provisional application No. 63/566,818, filed on Mar. 18, 2024.
(60) Provisional application No. 63/566,828, filed on Mar. 18, 2024.

(51) Int. Cl. C09K 8/584

(52) U.S. Cl. CPC C09K 8/584

(57) ABSTRACT

Described herein are methods for improving hydrocarbon production from a subterranean formation.

### CROSS-REFERENCE TO RELATED APPLICATION

This application claims priority to, and the benefit of U.S. Provisional Application 63/566,818, filed on Mar. 18, 2024 and U.S. Provisional Application No. 63/566,828, filed on Mar. 18, 2024, the contents of which are hereby incorporated in their entirety.

### BACKGROUND

There is an ongoing need to develop cost-effective and improved methods for oil recovery from hydrocarbon reservoirs.

### SUMMARY

Provided herein are methods for improving hydrocarbon production from subterranean formations, including unconventional subterranean formations, using a miscible solvent.

For example, provided herein are methods for improving hydrocarbon production from subterranean formation that include: (a) injecting a liquid formulation including a miscible solvent into the subterranean formation via a wellbore in fluid communication with the subterranean formation; and (b) allowing the miscible solvent to partition into hydrocarbons present within the subterranean formation for a period of time. In some embodiments, the subterranean formation can have a permeability of less than 0.1 mD (e.g., from 1.0×10⁻⁶ mD to less than 0.1 mD).

Also provided herein are methods for improving hydrocarbon production from a subterranean formation that include: (a) injecting a liquid formulation including a miscible solvent into the subterranean formation via a wellbore in fluid communication with the subterranean formation; and (b) allowing the miscible solvent to partition into hydrocarbons present within the subterranean formation for a period of time. In some embodiments, the miscible solvent can be injected in an effective amount to reduce the viscosity of the hydrocarbons present within the subterranean formation by at least 1%.

Also provided herein are methods for improving hydrocarbon production from a subterranean formation that includes: (a) injecting a volume of the miscible solvent into the subterranean formation via a wellbore in fluid communication with the subterranean formation; (b) allowing the miscible solvent to partition into hydrocarbons present within the subterranean formation for a period of time; and (c) producing fluids including the hydrocarbons from the subterranean formation through the wellbore. In some embodiments, the volume of the liquid formulation including the miscible solvent injected into the subterranean formation can be determined by the formula below:

$${V}_{o} = \frac{{V}_{o}}{[ \frac{{C}_{i , l}}{{C}_{i , o}} - \frac{1}{k} ]}$$

where C_{i,I}=injected concentration of miscible solvent in water; C_{i,w}=equilibrium concentration of miscible solvent in water; C_{i,o}=equilibrium concentration of miscible solvent in water; k=C_{i,o}/C_{i,w}; V_{w}=volume of the liquid formulation including the miscible solvent injected into the subterranean formulation; and Vₒ=volume of treated hydrocarbon.

### BRIEF DESCRIPTION OF THE DRAWINGS

FIG. 1 shows a schematic of aqueous DME treatment injected through a wellbore and into a subterranean formation to partition into the hydrocarbon phase within the formation at equilibrium.

FIG. 2 shows a graph of oil recovery using brine, surfactant formulation 1, and surfactant formulation 1 with DME solution.

FIG. 3 shows a graph of oil recovery with brine, surfactant formulation 1 with DME, surfactant formulation 2 with DME, and surfactant formulation 3 with DME solutions.

FIG. 4 shows a graph of oil recovery by 0.3% surfactant solution in approximately 128 kppm TDS.

FIG. 5 shows a graph of oil recovery by 0.15% surfactant solution and 5% DME in approximately 128 kppm TDS.

FIG. 6 shows a graph of oil recovery by 5% DME in approximately 128 kppm TDS.

FIG. 7 shows a graph of oil recovery by 0.5% surfactant solution and 5% DME.

FIG. 8 shows a graph of oil recovery by 0.15% surfactant solution and different concentrations of DME.

FIG. 9 shows a graph of oil recovery by 0.15% surfactant solution and different concentrations of DME.

FIG. 10 shows a graph of oil recovery by 5% DME and 0.15% Formulation 1.

FIG. 11 shows a graph of oil recovery by Formulation 4.

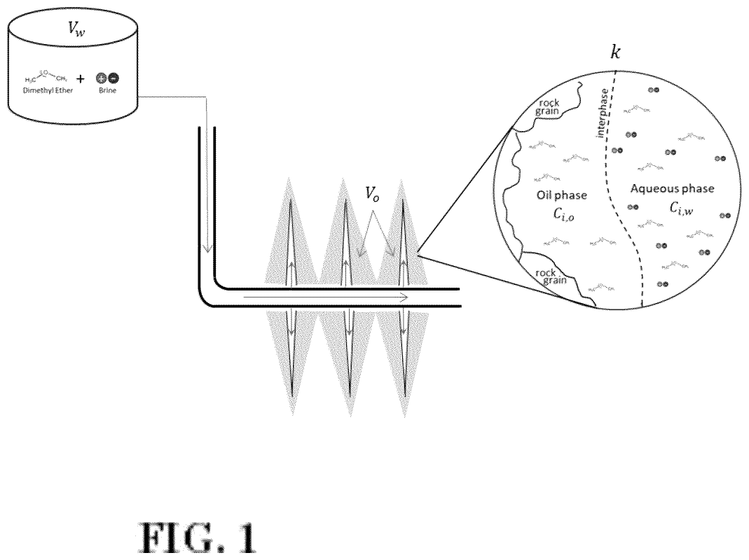

The drawings illustrate only example embodiments of methods, systems, and devices for stabilizing injection fluids and are therefore not to be considered limiting of its scope, as aspects of the disclosure may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

### DETAILED DESCRIPTION

A number of embodiments of the disclosure have been described. Nevertheless, it will be understood that various modifications may be made without departing from the spirit and scope of the invention. Accordingly, other embodiments are within the scope of the following claims.

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Unless otherwise specified, all percentages are in weight percent and the pressure is in atmospheres. All citations referred to herein are expressly incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Ranges can be expressed herein as from “about” one particular value, and/or to “about” another particular value. By “about” is meant within 10% of the value, e.g., within 9, 8, 7, 6, 5, 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if a composition is described herein as including a component of type A, a component of type B, a component of type C, or any combination thereof, it is understood that this phrase describes all of the various individual and collective combinations and permutations of these components.

For example, in some embodiments, the composition described by this phrase could include only a component of type A. In some embodiments, the composition described by this phrase could include only a component of type B. In some embodiments, the composition described by this phrase could include only a component of type C. In some embodiments, the composition described by this phrase could include a component of type A and a component of type B. In some embodiments, the composition described by this phrase could include a component of type A and a component of type C. In some embodiments, the composition described by this phrase could include a component of type B and a component of type C. In some embodiments, the composition described by this phrase could include a component of type A, a component of type B, and a component of type C. In some embodiments, the composition described by this phrase could include two or more components of type A (e.g., A1 and A2). In some embodiments, the composition described by this phrase could include two or more components of type B (e.g., B1 and B2). In some embodiments, the composition described by this phrase could include two or more components of type C (e.g., C1 and C2). In some embodiments, the composition described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the composition described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the composition described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

The term “hydrocarbon” refers to a compound containing only carbon and hydrogen atoms.

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” generally refers to geologic formations of interest, that the term “formation,” as used herein, may, in some instances, include any geologic points or volumes of interest (such as a survey area).

“Unconventional formation” is a subterranean hydrocarbon-bearing formation that generally requires intervention in order to recover hydrocarbons from the reservoir at economic flow rates or volumes. For example, an unconventional formation includes reservoirs having an unconventional microstructure in which fractures are used to recover hydrocarbons from the reservoir at sufficient flow rates or volumes (e.g., an unconventional reservoir generally needs to be fractured under pressure or have naturally occurring fractures in order to recover hydrocarbons from the reservoir at sufficient flow rates or volumes).

In some embodiments, the unconventional formation can include a reservoir having a permeability of less than 25 millidarcy (mD) (e.g., 20 mD or less, 15 mD or less, 10 mD or less, 5 mD or less, 1 mD or less, 0.5 mD or less, 0.1 mD or less, 0.05 mD or less, 0.01 mD or less, 0.005 mD or less, 0.001 mD or less, 0.0005 mD or less, 0.0001 mD or less, 0.00005 mD or less, 0.00001 mD or less, 0.000005 mD or less, 0.000001 mD or less, or less). In some embodiments, the unconventional formation can include a reservoir having a permeability of at least 0.000001 mD (e.g., at least 0.000005 mD, at least 0.00001 mD, 0.00005 mD, at least 0.0001 mD, 0.0005 mD, 0.001 mD, at least 0.005 mD, at least 0.01 mD, at least 0.05 mD, at least 0.1 mD, at least 0.5 mD, at least 1 mD, at least 5 mD, at least 10 mD, at least 15 mD, or at least 20 mD).

The unconventional formation can include a reservoir having a permeability ranging from any of the minimum values described above to any of the maximum values described above. For example, in some embodiments, the unconventional formation can include a reservoir having a permeability of from 0.000001 mD to 25 mD (e.g., from 0.001 mD to 25 mD, from 0.001 mD to 10 mD, from 0.01 mD to 10 mD, from 0.1 mD to 10 mD, from 0.001 mD to 5 mD, from 0.01 mD to 5 mD, or from 0.1 mD to 5 mD). The permeability of a particular formation can be determined by averaging measured permeability values from a series of representative core samples obtained from the formation.

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (also known as oil or petroleum), gas hydrocarbons, a combination of liquid hydrocarbons and gas hydrocarbons (e.g., including gas condensate), etc.

The formation, the hydrocarbons, or both may also include non-hydrocarbon items, such as pore space, connate water, brine, fluids from oil recovery, etc. The formation may also be divided up into one or more hydrocarbon zones, and hydrocarbons can be produced from each desired hydrocarbon zone.

The term formation may be used synonymously with the term “reservoir” or “subsurface reservoir” or “subsurface region of interest” or “subsurface formation” or “subsurface volume of interest” or “subterranean formation”. For example, in some embodiments, the reservoir may be, but is not limited to, a shale reservoir, a carbonate reservoir, a tight sandstone reservoir, a tight siltstone reservoir, etc. Indeed, the terms “formation,” “hydrocarbon,” and the like are not limited to any description or configuration described herein.

A “wellbore” refers to a single hole, usually cylindrical, that is drilled into a subsurface volume of interest. A wellbore may be drilled in one or more directions. For example, a wellbore may include a vertical wellbore, a horizontal wellbore, a deviated wellbore, and/or other type of wellbore. A wellbore may be drilled in the formation for exploration and/or recovery of resources. For example, a wellbore may be drilled in the formation to aid in extraction and/or production of resources such as hydrocarbons. As another example, a wellbore may be drilled in the formation for fluid injection. A plurality of wellbores (e.g., tens to hundreds of wellbores) are often used in a field depending on the desired outcome.

A wellbore may be drilled into a formation using practically any drilling technique and equipment known in the art, such as geosteering, directional drilling, etc. Drilling the wellbore may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling (SWD) tools, wireline tools, logging-while-drilling (LWD) tools, or other downhole tools. After drilling to a predetermined depth, the drill string and the drill bit may be removed, and then the casing, the tubing, and/or other equipment may be installed according to the design of the wellbore may be installed according to the design of the wellbore. The equipment to be used in drilling the wellbore may be dependent on the design of the wellbore, the formation, the hydrocarbons, and/or other factors.

A wellbore may include a plurality of components, such as, but not limited to, a casing, a liner, a tubing string, a sensor, a packer, a screen, a gravel pack, artificial lift equipment (e.g., an electric submersible pump (ESP)), and/or other components. If a wellbore is drilled offshore, the wellbore may include one or more of the previous components plus other offshore components, such as a riser. A wellbore may also include equipment to control fluid flow into the wellbore, control fluid flow out of the wellbore, or any combination thereof. For example, a wellbore may include a wellhead, a choke, a valve, and/or other control devices. These control devices may be located on the surface, in the subsurface (e.g., downhole in the wellbore), or any combination thereof. In some embodiments, the same control devices may be used to control fluid flow into and out of the wellbore. In some embodiments, different control devices may be used to control fluid flow into and out of a wellbore. In some embodiments, the rate of flow of fluids through the wellbore may depend on the fluid handling capacities of the surface facility that is in fluidic communication with the wellbore. The equipment to be used in controlling fluid flow into and out of a wellbore may be dependent on the wellbore, the formation, the surface facility, and/or other factors. Moreover, sand control equipment and/or sand monitoring equipment may also be installed (e.g., downhole and/or on the surface). A wellbore may also include any completion hardware that is not discussed separately. The term “wellbore” may be used synonymously with the terms “borehole,” “well,” or “well bore.” The term “wellbore” is not limited to any description or configuration described herein.

The term “proximate” is defined as “near”. If item A is proximate to item B, then item A is near item B. For example, in some embodiments, item A may be in contact with item B. For example, in some embodiments, there may be at least one barrier between item A and item B such that item A and item B are near each other, but not in contact with each other. The barrier may be a fluid barrier, a non-fluid barrier (e.g., a structural barrier), or any combination thereof. Both scenarios are contemplated within the meaning of the term “proximate.”

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e., organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) (i.e., API gravity) and market price in comparison to light (or sweet) crude oils. Crude oil may also be characterized by its Equivalent Alkane Carbon Number (EACN). The term “API gravity” refers to the measure of how heavy or light a petroleum liquid is compared to water. If an oil's API gravity is greater than 10, it is lighter and floats on water, whereas if it is less than 10, it is heavier and sinks. API gravity is thus an inverse measure of the relative density of a petroleum liquid and the density of water. API gravity may also be used to compare the relative densities of petroleum liquids. For example, if one petroleum liquid floats on another and is therefore less dense, it has a greater API gravity.

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin-based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Reactive” crude oil, as referred to herein, is crude oil containing natural organic acidic components (also referred to herein as unrefined petroleum acid) or their precursors such as esters or lactones. These reactive crude oils can generate soaps (carboxylates) when reacted with alkali. More terms used interchangeably for crude oil throughout this disclosure are hydrocarbons, hydrocarbon material, or active petroleum material. An “oil bank” or “oil cut” as referred to herein, is the crude oil that does not contain the injected chemicals and is pushed by the injected fluid during an oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali. A nonactive oil as referred to herein includes oils having an acid number of less than 0.5 mg KOH/g of oil.

“Unrefined petroleum acids” as referred to herein are carboxylic acids contained in active petroleum material (reactive crude oil). The unrefined petroleum acids contain C₁₁-C₂₀ alkyl chains, including napthenic acid mixtures. The recovery of such “reactive” oils may be performed using alkali (e.g., NaOH, NaHCO₃, or Na₂CO₃) in a surfactant composition. The alkali reacts with the acid in the reactive oil to form soap in situ. These in situ generated soaps serve as a source of surfactants minimizing the levels of added surfactants, thus enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “productivity” as applied to a petroleum or oil well refers to the capacity of a well to produce hydrocarbons (e.g., unrefined petroleum); that is, the ratio of the hydrocarbon flow rate to the pressure drop, where the pressure drop is the difference between the average reservoir pressure and the flowing bottom hole well pressure (i.e., flow per unit of driving force).

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in an aqueous phase. Examples for such salts are without limitation, sodium chloride, magnesium and calcium sulfates, and bicarbonates. In more particular, the term salinity as it pertains to the present invention refers to the concentration of salts in brine and surfactant solutions.

“Fracturing fluid,” as used herein, refers to an injection fluid that is injected into the well under pressure in order to cause fracturing within a portion of the reservoir.

Unless defined otherwise, all technical and scientific terms used herein have the same meanings as commonly understood by one of skill in the art to which the disclosed invention belongs. Unless otherwise specified, all percentages are in weight percent and the pressure is in atmospheres.

### Methods

Described herein are methods for improving hydrocarbon production from subterranean formations, including unconventional subterranean formations, using miscible solvent.

For example, described herein are methods for improving hydrocarbon production from subterranean formation that include (a) injecting a liquid formulation including a miscible solvent into the subterranean formation via a wellbore in fluid communication with the subterranean formation; and (b) allowing the miscible solvent to partition into hydrocarbons present within the subterranean formation for a period of time.

In some embodiments, the methods can further include producing fluids including the hydrocarbons from the subterranean formation. In some embodiments, the methods can further include recovering the miscible solvent from the fluids including the hydrocarbons produced from the subterranean formation. In some embodiments, the method can further include injecting at least a portion of the recovered miscible solvent into the subterranean formation via a wellbore in fluid communication with the subterranean formation.

The miscible solvent can be allowed to partition into hydrocarbons present within the subterranean formation for varying periods of time. In some examples, the miscible solvent can be allowed to partition into hydrocarbons present within the subterranean formation for at least one day (e.g., at least two days, at least three days, at least four days, at least five days, at least six days, at least one week, at least two weeks, at least three weeks, at least one month, at least two months, at least three months, at least four months, or at least five months). In some examples, the miscible solvent can be allowed to partition into hydrocarbons present within the subterranean formation for six months or less (e.g., five months or less, four months or less, three months or less, two months or less, one month or less, three weeks or less, two weeks or less, one week or less, six days or less, five days or less, four days or less, three days or less, or two days or less).

The miscible solvent can be allowed to partition into hydrocarbons present within the subterranean formation for a period of time ranging from any of the minimum values described above to any of the maximum values described above. For example, the miscible solvent can be allowed to partition into hydrocarbons present within the subterranean formation for from one day to six months (e.g., from one day to three months, from one day to one month, or from one day to two weeks).

In one example, the wellbore can be a new wellbore, and the miscible solvent can be allowed to partition into the hydrocarbons present within the subterranean formation for from two weeks to one month. In another example, the wellbore can be a wellbore proximate to a previously fractured region of the subterranean formation, and the miscible solvent can be allowed to partition into the hydrocarbons present within the subterranean formation for from one day to two weeks.

In some embodiments, the miscible solvent exhibits a partition coefficient of at least 0.01 (e.g., at least 0.05, at least 0.1, at least 0.2, at least 0.25, at least 0.3, at least 0.4, at least 0.5, at least 0.6, at least 0.7, at least 0.75, at least 0.8, at least 0.9, at least 1.0, at least 1.05, at least 1.1, at least 1.15, at least 1.2, at least 1.25, at least 1.5, at least 2, or at least 2.5) with the hydrocarbons present in the subterranean formation. In some embodiments, the miscible solvent exhibits a partition coefficient of 3 or less (e.g., 2.5 or less, 2 or less, 1.5 or less, 1.25 or less, 1.2 or less, 1.15 or less, 1.1 or less, 1.05 or less, 1.0 or less, 0.9 or less, 0.8 or less, 0.75 or less, 0.7 or less, 0.6 or less, 0.5 or less, 0.4 or less, 0.3 or less, 0.25 or less, 0.2 or less, 0.1 or less, or 0.05 or less) with the hydrocarbons present in the subterranean formation.

The miscible solvent can exhibit a partition coefficient ranging from any of the minimum values described above. For example, in some embodiments, the miscible solvent can exhibit a partition coefficient of from 0.01 to 3 (e.g., from 0.01 to 2.5, from 0.01 to 2, from 0.01 to 1.5, from 0.01 to 1.0, from 0.01 to 0.5, from 0.01 to 0.25, from 0.01 to 0.1, from 0.01 to 0.05, from 0.05 to 3, from 0.05 to 2.5, from 0.05 to 2, from 0.05 to 1.5, from 0.05 to 1.0, from 0.05 to 0.5, from 0.05 to 0.25, from 0.05 to 0.1, from 0.1 to 3, from 0.1 to 2.5, from 0.1 to 2, from 0.1 to 1.5, from 0.1 to 1.0, from 0.1 to 0.5, from 0.5 to 3, from 0.5 to 2.5, from 0.5 to 2, from 0.5 to 1.5, from 0.5 to 1.0, from 1 to 3, from 1 to 2.5, from 1 to 2, from 1 to 1.5, from 1.5 to 3, from 1.5 to 2.5, from 1.5 to 2, from 2 to 2.5, or from 2 to 3) with the hydrocarbons present in the subterranean formation.

In some embodiments, the subterranean formation can be an unconventional subterranean formation. In some embodiments, the subterranean formation can have a permeability of 0.1 millidarcy (mD) or less (e.g., 0.05 mD or less, 0.01 mD or less, 5.0×10⁻³ mD or less, 1.0×10⁻³ mD or less, 5.0×10⁻⁴ mD or less, 1.0×10⁻⁴ mD or less, 5.0×10⁻⁵ mD or less, 1.0×10⁻⁵ mD or less, or 5.0×10⁻⁶ mD or less). In some embodiments, the subterranean formation can have a permeability of at least 1.0×10⁻⁶ mD (e.g., at least 5.0×10⁻⁶ mD, at least 1.0×10⁻⁵ mD, at least 5.0×10⁻⁵, at least 1.0×10⁻⁴ mD, at least 5.0×10⁻⁴, at least 1.0×10⁻³ mD, at least 5.0×10⁻³, at least 0.01, or at least 0.05).

In some embodiments, the subterranean formation can have a permeability ranging from any of the minimum values described above to any of the maximum values described above. For example, in some embodiments, the subterranean formation can have a permeability of from 1.0×10⁻⁶ mD to less than 0.1 mD (e.g., from 5.0×10⁻⁶ mD to 0.1 mD, from 1.0×10⁻⁵ mD to 0.1 mD, 5.0×10⁻⁵ mD to 0.1 mD, from 1.0×10⁻⁴ mD to 0.1 mD, 5.0×10⁻⁴ mD to 0.1 mD, from 1.0×10⁻³ mD to 0.1 mD, 5.0×10⁻³ mD to 0.1 mD, from 0.01 mD to 0.1 mD, 0.05 mD to 0.1 mD, from 1.0×10⁻⁶ mD to 0.05 mD, from 5.0×10⁻⁶ mD to 0.05 mD, from 1.0×10⁻⁵ mD to 0.05 mD, 5.0×10⁻⁵ mD to 0.05 mD, from 1.0×10⁻⁴ mD to 0.05 mD, from 5.0×10⁻⁴ mD to 0.05 mD, from 1.0×10⁻³ mD to 0.05 mD, 5.0×10⁻³ mD to 0.05 mD, from 0.01 mD to 0.05 mD, from 1.0×10⁻⁶ mD to 0.01 mD, from 5.0×10⁻⁶ mD to 0.01 mD, from 1.0×10⁻⁵ mD to 0.01 mD, from 5.0×10⁻⁵ mD to 0.01 mD, from 1.0×10⁻⁴ mD to 0.01 mD, 5.0×10⁻⁴ mD to 0.01 mD, from 1.0×10⁻³ mD to 0.01 mD, 5.0×10⁻³ mD to 0.01 mD, from 1.0×10⁻⁶ mD to 5.0×10⁻³ mD, from 5.0×10⁻⁶ mD to 5.0×10⁻³ mD, from 1.0×10⁻¹ mD to 5.0×10⁻³ mD, 5.0×10⁻¹ mD to 5.0×10⁻³ mD, from 1.0×10⁻⁴ mD to 5.0×10⁻³ mD, from 5.0×10⁻⁴ mD to 5.0×10⁻³ mD, from 1.0×10⁻³ mD to 5.0×10⁻³ mD, from 1.0×10⁻⁶ mD to 1.0×10⁻³ mD, from 5.0×10⁻⁶ mD to 1.0×10⁻³ mD, from 1.0×10⁻⁵ mD to 1.0×10⁻³ mD, from 5.0×10⁻¹ mD to 1.0×10⁻³ mD, from 1.0×10⁻⁴ mD to 1.0×10⁻³ mD, 5.0×10⁻⁴ mD to 1.0×10⁻³ mD, from 1.0×10⁻⁶ mD to 5.0×10⁻⁴ mD, from 5.0×10⁻⁶ mD to 5.0×10⁻⁴ mD, from 1.0×10⁻⁵ mD to 5.0×10⁻⁴ mD, from 5.0×10⁻⁵ mD to 5.0×10⁻⁴ mD, from 1.0×10⁻⁶ mD to 1.0×10⁻⁴ mD, from 5.0×10⁻⁶ mD to 1.0×10⁻⁴ mD, from 1.0×10⁻⁵ mD to 1.0×10⁻⁴ mD, from 5.0×10⁻⁵ mD to 1.0×10⁻⁴ mD, from 1.0×10⁻⁶ mD to 5.0×10⁻⁵ mD, from 5.0×10⁻⁶ mD to 5.0×10⁻⁵ mD, from 1.0×10⁻⁵ mD to 5.0×10⁻⁵ mD, from 1.0×10⁻⁶ mD to 1.0×10⁻⁵ mD, from 5.0×10⁻⁶ mD to 1.0×10⁻⁵ mD, or from 1.0×10⁻⁶ mD to 5.0×10⁻⁶ mD).

In some embodiments, the volume of the miscible solvent injected into the subterranean formation can determined by the formula below:

$${V}_{o} = \frac{{V}_{o}}{[ \frac{{C}_{i , l}}{{C}_{i , o}} - \frac{1}{k} ]}$$

where C_{i,I}=injected concentration of miscible solvent in water; C_{i,w}=equilibrium concentration of miscible solvent in water; C_{i,o}=equilibrium concentration of miscible solvent in water; k=C_{i,o}/C_{i,w}; V_{w}=volume of the liquid formulation including the miscible solvent injected into the subterranean formulation; and Vₒ=volume of treated hydrocarbon.

In some embodiments, the method improves the hydrocarbon recovery by at least 10% (e.g., at least 15%, at least 20%, at least 25%, at least 30%, at least 35%, at least 40%) relative to injection brine having a TDS of 128,000 ppm. In some embodiments, the method improves the hydrocarbon recovery by at least 25% relative to injection brine having a TDS of 128,000 ppm.

In some embodiments, the miscible solvent can include, but is not limited to, dimethyl ether (DME), C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, sec-butanol, tert-butanol, pentaerythritol, trimethylolpropane), or any combination thereof.

In some embodiments, the miscible solvent can be dimethyl ether (DME). In some embodiments, the miscible solvent can be neat dimethyl ether.

In some embodiments, the liquid formulation includes DME. In some embodiments, the liquid formulation includes neat dimethyl ether.

In other embodiments, the liquid formulation can include one or more additional components.

In some embodiments, the method can further include preparing the liquid formulation including a miscible solvent. For example, in some embodiments, the method can further include combining the miscible solvent described herein with additional components to form a miscible solvent formulation.

In some embodiments, the liquid formulation including the miscible solvent can include at least 1% (e.g., at least 5%, at least 10%, at least 15%, at least 20%, at least 25%, at least 30%, or at least 35%) by weight of the miscible solvent.

In some embodiments, the liquid formulation including the miscible solvent can include 40% or less (e.g., 35% or less, 30% or less, 25% or less, 20% or less, 15% or less, 10% or less, or 5% or less) by weight of the miscible solvent.

In some embodiments, the amount of miscible solvent present in the liquid formulation including miscible solvent can range from any of the minimum values described above to any of the maximum values described above. For example, in some embodiment, the amount of the miscible solvent present in the liquid formulation including the miscible solvent can include from 1% to 40% by weight miscible solvent (e.g., from 1% to 5%, from 1% to 10%, from 1% to 15%, from 1% to 20%, from 1% to 25%, from 1% to 30%, from 1% to 35%, from 5% to 10%, from 5% to 15%, from 5% to 20%, from 5% to 25%, from 5% to 30%, from 5% to 35%, from 5% to 40%, from 10% to 15%, from 10% to 20%, from 10% to 25%, from 10% to 30%, from 10% to 35%, from 10% to 40%, from 15% to 20%, from 15% to 25%, from 15% to 30%, from 15% to 35%, from 15% to 40%, from 20% to 25%, from 20% to 30%, from 20% to 35%, from 20% to 40%, from 25% to 30%, from 25% to 35%, from 25% to 40%, from 30% to 35%, from 30% to 40%, or from 35% to 40%) by weight miscible solvent. In some embodiments, the liquid formulation including miscible solvent can include from 1% to 20%, from 3% to 12%, or from 5% to 9% miscible solvent by weight.

Optionally, the liquid formulation including miscible solvent can include one or more additional components. For example, the liquid formulation including the miscible solvent can further include water, surfactant, a friction reducer, a pH adjusting agent, an iron control agent, a corrosion inhibitor, a scale inhibitor, a biocide, a clay stabilizing agent, co-solvent or any combination thereof. In some embodiments, the liquid formulation including the miscible solvent can further include a friction reducer, a pH adjusting agent, an iron control agent, a corrosion inhibitor, a scale inhibitor, a biocide, a clay stabilizing agent, or any combination thereof.

In some embodiments, the liquid formulation including the miscible solvent can further include one or more co-solvents. Suitable co-solvents include alcohols, such as lower carbon chain alcohols such as isopropyl alcohol, ethanol, n-propyl alcohol, n-butyl alcohol, sec-butyl alcohol, n-amyl alcohol, sec-amyl alcohol, n-hexyl alcohol, sec-hexyl alcohol and the like; alcohol ethers, polyalkylene alcohol ethers, polyalkylene glycols, poly(oxyalkylene)glycols, poly(oxyalkylene)glycol ethers, ethoxylated phenol, or any other common organic co-solvent or combinations of any two or more co-solvents. In one embodiment, the co-solvent can include alkyl ethoxylate (C1-C6)-XEO X=1-30-linear or branched. In some embodiments, the co-solvent can include ethylene glycol butyl ether (EGBE), diethylene glycol monobutyl ether (DGBE), triethylene glycol monobutyl ether (TEGBE), ethylene glycol dibutyl ether (EGDE), polyethylene glycol monomethyl ether (mPEG), or any combination thereof. In some embodiments, the miscible solvent formulation can further include a co-solvent (e.g., a C1-C5 alcohol, or an alkoxylated C₁-C5 alcohol), or any combination thereof).

In some embodiments, the co-solvent can have a concentration within the liquid formulation including the miscible solvent of at least 0.5% by weight (e.g., at least 1%, at least 5%, at least 10%, at least 20%, at least 30%, at least 40%, or at least 50%).

In some embodiments, the co-solvent can have a concentration within the liquid formulation including the miscible solvent of 60% or less by weight (e.g., 50% or less, 40% or less, 30% or less, 20% or less, 10% or less, 5% or less, or 1% or less).

The co-solvent can have a concentration within the liquid formulation including the miscible solvent ranging from any of the minimum values described above to any of the maximum values described above. For example, in some embodiments, the co-solvent can have a concentration within the liquid formulation including the miscible solvent of from 0.5% to 60% by weight (e.g., from 0.5% to 50%, from 0.5% to 40%, from 0.5% to 30%, from 0.5% to 20%, from 0.5% to 10%, from 0.5% to 5%, from 0.5% to 1%, from 1% to 50%, from 1% to 40%, from 1% to 30%, from 1% to 20%, from 1% to 10%, from 1% to 5%, from 5% to 50%, from 5% to 40%, from 5% to 30%, from 5% to 20%, from 5% to 10%, from 10% to 50%, from 10% to 40%, from 10% to 30%, from 10% to 20%, from 20% to 50%, from 20% to 40%, from 20% to 30%, from 30% to 50%, from 30% to 40%, or from 40% to 50%).

In some embodiments, the liquid formulation including the miscible solvent can further include water. The water used to form the compositions can include any type of water, treated or untreated, and can vary in salt content. For example, the water can include sea water, brackish water, flowback or produced water, wastewater (e.g., reclaimed or recycled), brine (e.g., reservoir or synthetic brine), fresh water (e.g., fresh water comprises <1,000 ppm TDS water), or any combination thereof. In certain examples, the water can include hard water or hard brine. In some embodiments, the water can include at least 10 ppm of divalent metal ions (e.g., at least 100 ppm, at least 500 ppm, at least 1,000 ppm, at least 5,000 ppm, at least 10,000 ppm, at least 20,000 ppm, or at least 30,000 ppm). In some embodiments, the water can include 30,000 ppm or less of divalent metal ions (e.g., 20,000 ppm or less, 10,000 ppm or less, 5,000 ppm or less, 1,000 ppm or less, 500 ppm or less, 100 ppm or less, or 50 ppm or less). In certain embodiments, the from 10 ppm to 30,000 ppm of divalent metal ions.

The water can have a concentration of divalent metal ions ranging from any of the minimum values described above to any of the maximum values described above. For example, in some embodiments, the water can include from 10 ppm to 30,000 ppm of divalent metal ions (e.g., from 50 ppm to 30,000 ppm, from 100 ppm to 30,000 ppm, from 500 ppm to 30,000 ppm, from 1000 ppm to 30,000 ppm, from 5000 ppm to 30,000 ppm, from 10,000 ppm to 30,000 ppm, from 20,000 ppm to 30,000 ppm, from 10 ppm to 20,000 ppm, from 50 ppm to 20,000 ppm, from 100 ppm to 20,000 ppm, from 500 ppm to 20,000 ppm, from 1000 ppm to 20,000 ppm, from 5000 ppm to 20,000 ppm, from 10,000 ppm to 20,000 ppm, from 10 ppm to 10,000 ppm, from 50 ppm to 10,000 ppm, from 100 ppm to 10,000 ppm, from 500 ppm to 10,000 ppm, from 1000 ppm to 10,000 ppm, from 5000 ppm to 10,000 ppm, from 10 ppm to 5,000 ppm, from 50 ppm to 5,000 ppm, from 100 ppm to 5,000 ppm, from 500 ppm to 5,000 ppm, from 1000 ppm to 5,000 ppm, from 10 ppm to 1,000 ppm, from 50 ppm to 1,000 ppm, from 100 ppm to 20,000 ppm, from 500 ppm to 1,000 ppm, from 10 ppm to 500 ppm, from 50 ppm to 500 ppm, from 100 ppm to 500 ppm, from 10 ppm to 100 ppm, from 50 ppm to 100 ppm, or from 10 ppm to 50 ppm).

In some embodiments, the divalent metal ions can be chosen from Ca²⁺, Mg²⁺, Sr²⁺, and Ba²⁺, or any combination thereof.

In some embodiments, the water can have salinity of at least 5,000 ppm TDS (e.g., at least 10,000 ppm TDS, at least 20,000 ppm TDS, at least 30,000 ppm TDS, at least 50,000 ppm TDS, at least 75,0000 ppm TDS, at least 100,000 ppm TDS, at least 150,000 ppm TDS, at least 200,000 ppm TDS, at least 250,000 ppm TDS, or at least 275,000 ppm TDS). In some embodiments, the water can have a salinity of 300,000 ppm TDS or less (e.g., 275,000 ppm TDS or less, 250,000 ppm TDS or less, 200,000 ppm TDS or less, 150,000 ppm TDS or less, 100,000 ppm TDS or less, 50,000 ppm TDS or less, 30,000 ppm TDS or less, 25,000 ppm TDS or less, 20,000 ppm TDS or less, 15,000 ppm TDS or less, or 10,000 ppm TDS or less).

The water can have a salinity ranging from any of the minimum values described above to any of the maximum values described above. For example, in some embodiments, the water can have a salinity of at least 5,000 ppm TDS to 300,000 ppm TDS, such as a salinity of from 5,000 ppm TDS to 10,000 ppm TDS, from 5,000 ppm TDS to 15,000 ppm TDS, from 5,000 ppm TDS to 30,000 ppm TDS, from 5,000 ppm TDS to 50,000 ppm TDS, from 5,000 ppm TDS to 100,000 ppm TDS, from 5,000 ppm TDS to 150,000 ppm TDS, from 5,000 ppm TDS to 200,000 ppm TDS, from 5,000 ppm TDS to 250,000 ppm TDS, from 5,000 ppm TDS to 300,000 ppm TDS, from 15,000 ppm TDS to 30,000 ppm TDS, from 15,000 ppm TDS to 50,000 ppm TDS, from 15,000 ppm TDS to 100,000 ppm TDS, from 15,000 ppm TDS to 150,000 ppm TDS, from 15,000 ppm TDS to 200,000 ppm TDS, from 15,000 ppm TDS to 250,000 ppm TDS, from 15,000 ppm TDS to 300,000 ppm TDS, from 20,000 ppm TDS to 50,000 ppm TDS, from 20,000 ppm TDS to 100,000 ppm TDS, from 20,000 ppm TDS to 150,000 ppm TDS, from 20,000 ppm TDS to 200,000 ppm TDS, from 20,000 ppm TDS to 250,000 ppm TDS, from 20,000 ppm TDS to 300,000 ppm TDS, from 25,000 ppm TDS to 50,000 ppm TDS, from 25,000 ppm TDS to 100,000 ppm TDS, from 25,000 ppm TDS to 150,000 ppm TDS, from 25,000 ppm TDS to 200,000 ppm TDS, from 25,000 ppm TDS to 250,000 ppm TDS, from 25,000 ppm TDS to 300,000 ppm TDS, from 50,000 ppm TDS to 100,000 ppm TDS, from 50,000 ppm TDS to 150,000 ppm TDS, from 50,000 ppm TDS to 200,000 ppm TDS, from 50,000 ppm TDS to 250,000 ppm TDS, from 50,000 ppm TDS to 300,000 ppm TDS, from 100,000 ppm TDS to 150,000 ppm TDS, from 100,000 ppm TDS to 200,000 ppm TDS, from 100,000 ppm TDS to 250,000 ppm TDS, from 100,000 ppm TDS to 300,000 ppm TDS, from 150,000 ppm TDS to 200,000 ppm TDS, from 150,000 ppm TDS to 250,000 ppm TDS, from 150,000 ppm TDS to 300,000 ppm TDS, from 200,000 ppm TDS to 250,000 ppm TDS, from 200,000 ppm TDS to 300,000 ppm TDS, or from 250,000 ppm TDS to 300,000 ppm TDS.

In some embodiments, the liquid formulation including the miscible solvent can further include a surfactant.

In some embodiments, when the liquid formulation including the miscible solvent includes a surfactant, the liquid formulation including the miscible solvent can include at least 1% (e.g., at least 5%, at least 10%, or at least 15%) by weight of the miscible solvent.

In some embodiments, when the liquid formulation including the miscible solvent includes a surfactant, the liquid formulation including the miscible solvent can include 20% or less (e.g., 15% or less, 10% or less, or 5% or less) by weight of the miscible solvent.

In some embodiments, when the liquid formulation including the miscible solvent includes a surfactant, the liquid formulation including the miscible solvent can include the miscible solvent in an amount ranging from any of the minimum values described above to any of the maximum values described above. For example, in some embodiments, the liquid formulation including the miscible solvent can include from 1% to 20% by weight of the miscible solvent (e.g., from 1% to 5%, from 1% to 10%, from 1% to 15%, from 1% to 20%, from 5% to 10%, from 5% to 15%, from 5% to 20%, from 10% to 15%, from 10% to 20%, or from 15% to 20%) by weight of the miscible solvent.

In some embodiments, when the liquid formulation including the miscible solvent includes a surfactant, the liquid formulation including the miscible solvent can include at least 3% (e.g., at least 5%, at least 10%) by weight of the miscible solvent.

In some embodiments, when the liquid formulation including the miscible solvent does not include a surfactant, the liquid formulation including the miscible solvent can include 15% or less (e.g., 10% or less, or 5% or less) by weight of the miscible solvent.

In some embodiments, when the liquid formulation including the miscible solvent does not include a surfactant, the liquid formulation including the miscible solvent can include the miscible solvent in an amount ranging from any of the minimum values described above to any of the maximum values described above. For example, in some embodiments, the liquid formulation including the miscible solvent can include from 3% to 15% by weight of the miscible solvent (e.g., from 3% to 5%, from 3% to 10%, from 5% to 10%, from 5% to 15%, from 10% to 15%,) by weight of the miscible solvent.

In some embodiments, the surfactant can include a non-ionic surfactant, an anionic surfactant, or any combination thereof. In some embodiments, the hydrophilic-lipophilic balance (HLB) of the non-ionic surfactant is greater than 10 (e.g., greater than 9, greater than 8, or greater than 7). In some embodiments, the HLB of the non-ionic surfactant is from 7 to 10.

The non-ionic surfactant can include a hydrophobic tail comprising from 6 to 60 carbon atoms. In some embodiments, the non-ionic surfactant can include a hydrophobic tail that can include at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the non-ionic surfactant can include a hydrophobic tail that includes 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The non-ionic surfactant can include a hydrophobic tail that includes a number of carbon atoms ranging from any of the minimum values described above to any of the maximum values described above. For example, the non-ionic surfactant can include a hydrophobic tail including from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 11 to 15, from 16 to 25, from 26 to 35, or from 36 to 45 carbon atoms. In some cases, the hydrophobic tail may be a straight chain, branched chain, and/or may include cyclic structures. The hydrophobic carbon tail may include single bonds, double bonds, triple bonds, or any combination thereof. In some cases, the hydrophobic tail can include an alkyl group, with or without an aromatic ring (e.g., a phenyl ring) attached to it. In some embodiments, the hydrophobic tail can include a branched hydrophobic tail derived from Guerbet alcohols.

Example non-ionic surfactants include alkyl aryl alkoxy alcohols, alkyl alkoxy alcohols, or any combination thereof. In embodiments, the non-ionic surfactant may be a mix of surfactants with different length lipophilic tail chain lengths. For example, the non-ionic surfactant may be C9-C11:9EO, which indicates a mixture of non-ionic surfactants that have a lipophilic tail length of 9 carbon to 11 carbon, which is followed by a chain of 9 EOs. The hydrophilic moiety is an alkyleneoxy chain (e.g., an ethoxy (EO), butoxy (BO) and/or propoxy (PO) chain with two or more repeating units of EO, BO, and/or PO). In some embodiments, 1-100 repeating units of EO are present. In some embodiments, 0-65 repeating units of PO are present. In some embodiments, 0-25 repeating units of BO are present. For example, the non-ionic surfactant could include 10EO:5PO or 5EO. In embodiments, the non-ionic surfactant may be a mix of surfactants with different length lipophilic tail chain lengths. For example, the non-ionic surfactant may be C9-C11:PO9:EO2, which indicates a mixture of non-ionic surfactants that have a lipophilic tail length of 9 carbon to 11 carbon, which is followed by a chain of 9 POs and 2 EOs. In specific embodiments, the non-ionic surfactant is linear C9-C11:9EO. In some embodiments, the non-ionic surfactant is a Guerbet PO(0-65) and EO(0-100) (Guerbet can be C6-C36); or alkyl PO(0-65) and EO(0-100): where the alkyl group is linear or branched C1-C36. In some examples, the non-ionic surfactant can include a branched or unbranched C6-C32:PO(0-65):EO(0-100) (e.g., a branched or unbranched C6-C30:PO(30-40):EO(25-35), a branched or unbranched C6-C12:PO(30-40):EO(25-35), a branched or unbranched C6-30:EO(8-30), a branched or unbranched C11-15:EO(30-50), a branched or unbranched C11-15:EO(35-45), a branched or unbranched C16:22:EO(20-30), a branched or unbranched C16:22:EO(30-50), a branched or unbranched C16:22:EO(35-45), a branched or unbranched C22-30:EO(30-40):EO(25-35), or any combination thereof). In some embodiments, the non-ionic surfactant is one or more alkyl polyglucosides.

Suitable anionic surfactants can include a hydrophobic tail that includes from 6 to 60 carbon atoms. In some embodiments, the anionic surfactant can include a hydrophobic tail that includes at least 6 carbon atoms (e.g., at least 7 carbon atoms, at least 8 carbon atoms, at least 9 carbon atoms, at least 10 carbon atoms, at least 11 carbon atoms, at least 12 carbon atoms, at least 13 carbon atoms, at least 14 carbon atoms, at least 15 carbon atoms, at least 16 carbon atoms, at least 17 carbon atoms, at least 18 carbon atoms, at least 19 carbon atoms, at least 20 carbon atoms, at least 21 carbon atoms, at least 22 carbon atoms, at least 23 carbon atoms, at least 24 carbon atoms, at least 25 carbon atoms, at least 26 carbon atoms, at least 27 carbon atoms, at least 28 carbon atoms, at least 29 carbon atoms, at least 30 carbon atoms, at least 31 carbon atoms, at least 32 carbon atoms, at least 33 carbon atoms, at least 34 carbon atoms, at least 35 carbon atoms, at least 36 carbon atoms, at least 37 carbon atoms, at least 38 carbon atoms, at least 39 carbon atoms, at least 40 carbon atoms, at least 41 carbon atoms, at least 42 carbon atoms, at least 43 carbon atoms, at least 44 carbon atoms, at least 45 carbon atoms, at least 46 carbon atoms, at least 47 carbon atoms, at least 48 carbon atoms, at least 49 carbon atoms, at least 50 carbon atoms, at least 51 carbon atoms, at least 52 carbon atoms, at least 53 carbon atoms, at least 54 carbon atoms, at least 55 carbon atoms, at least 56 carbon atoms, at least 57 carbon atoms, at least 58 carbon atoms, or at least 59 carbon atoms). In some embodiments, the anionic surfactant can include a hydrophobic tail that includes 60 carbon atoms or less (e.g., 59 carbon atoms or less, 58 carbon atoms or less, 57 carbon atoms or less, 56 carbon atoms or less, 55 carbon atoms or less, 54 carbon atoms or less, 53 carbon atoms or less, 52 carbon atoms or less, 51 carbon atoms or less, 50 carbon atoms or less, 49 carbon atoms or less, 48 carbon atoms or less, 47 carbon atoms or less, 46 carbon atoms or less, 45 carbon atoms or less, 44 carbon atoms or less, 43 carbon atoms or less, 42 carbon atoms or less, 41 carbon atoms or less, 40 carbon atoms or less, 39 carbon atoms or less, 38 carbon atoms or less, 37 carbon atoms or less, 36 carbon atoms or less, 35 carbon atoms or less, 34 carbon atoms or less, 33 carbon atoms or less, 32 carbon atoms or less, 31 carbon atoms or less, 30 carbon atoms or less, 29 carbon atoms or less, 28 carbon atoms or less, 27 carbon atoms or less, 26 carbon atoms or less, 25 carbon atoms or less, 24 carbon atoms or less, 23 carbon atoms or less, 22 carbon atoms or less, 21 carbon atoms or less, 20 carbon atoms or less, 19 carbon atoms or less, 18 carbon atoms or less, 17 carbon atoms or less, 16 carbon atoms or less, 15 carbon atoms or less, 14 carbon atoms or less, 13 carbon atoms or less, 12 carbon atoms or less, 11 carbon atoms or less, 10 carbon atoms or less, 9 carbon atoms or less, 8 carbon atoms or less, or 7 carbon atoms or less).

The anionic surfactant can include a hydrophobic tail that includes a number of carbon atoms ranging from any of the minimum values described above to any of the maximum values described above. For example, in some embodiments, the anionic surfactant can include a hydrophobic tail including from 6 to 15, from 16 to 30, from 31 to 45, from 46 to 60, from 6 to 25, from 26 to 60, from 6 to 30, from 31 to 60, from 6 to 32, from 33 to 60, from 6 to 12, from 13 to 22, from 23 to 32, from 33 to 42, from 43 to 52, from 53 to 60, from 6 to 10, from 10 to 15, from 16 to 25, from 26 to 35, or from 36 to 45 carbon atoms. The hydrophobic (lipophilic) carbon tail may be a straight chain, branched chain, and/or may include cyclic structures. The hydrophobic carbon tail may include single bonds, double bonds, triple bonds, or any combination thereof. In some embodiments, the anionic surfactant can include a branched hydrophobic tail derived from Guerbet alcohols. The hydrophilic portion of the anionic surfactant can include, for example, one or more sulfate moieties (e.g., one, two, or three sulfate moieties), one or more sulfonate moieties (e.g., one, two, or three sulfonate moieties), one or more sulfosuccinate moieties (e.g., one, two, or three sulfosuccinate moieties), one or more carboxylate moieties (e.g., one, two, or three carboxylate moieties), or any combination thereof.

In some embodiments, the anionic surfactant can include, for example a sulfonate, a disulfonate, a polysulfonate, a sulfate, a disulfate, a polysulfate, a sulfosuccinate, a disulfosuccinate, a polysulfosuccinate, a carboxylate, a dicarboxylate, a polycarboxylate, or any combination thereof. In some examples, the anionic surfactant can include an internal olefin sulfonate (IOS), an isomerized olefin sulfonate, an alfa olefin sulfonate (AOS), an alkyl aryl sulfonate (AAS), a xylene sulfonate, an alkane sulfonate, a petroleum sulfonate, an alkyl diphenyl oxide (di)sulfonate, an alcohol sulfate, an alkoxy sulfate, an alkoxy sulfonate, an alkoxy carboxylate, an alcohol phosphate, or an alkoxy phosphate. In some embodiments, the anionic surfactant can include an alkoxy carboxylate surfactant, an alkoxy sulfate surfactant, an alkoxy sulfonate surfactant, an alkyl sulfonate surfactant, an aryl sulfonate surfactant, or an olefin sulfonate surfactant.

An “alkoxy carboxylate surfactant” or “alkoxy carboxylate” refers to a compound having an alkyl or aryl attached to one or more alkoxylene groups (typically —CH₂—CH(ethyl)-O—, —CH₂—CH(methyl)-O—, or —CH₂—CH₂—O—) which, in turn is attached to —COO⁻ or acid or salt thereof including metal cations such as sodium. In embodiments, the alkoxy carboxylate surfactant can be defined by the formulae below:

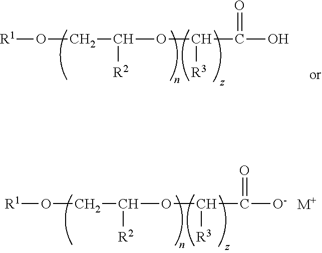

wherein R¹ is substituted or unsubstituted C6-C36 alkyl or substituted or unsubstituted aryl; R² is, independently for each occurrence within the compound, hydrogen or unsubstituted C1-C6 alkyl; R³ is independently hydrogen or unsubstituted C1-C6 alkyl, n is an integer from 0 to 175, z is an integer from 1 to 6 and M⁺ is a monovalent, divalent or trivalent cation. In some of these embodiments, R¹ can be an unsubstituted linear or branched C6-C36 alkyl.

In certain embodiments, the alkoxy carboxylate can be a C6-C32:PO(0-65):EO(0-100)-carboxylate (i.e., a C6-C32 hydrophobic tail, such as a branched or unbranched C6-C32 alkyl group, attached to from 0 to 65 propyleneoxy groups (—CH2-CH(methyl)-O— linkers), attached in turn to from 0 to 100 ethyleneoxy groups (—CH2-CH2-O— linkers), attached in turn to —COO— or an acid or salt thereof including metal cations such as sodium). In certain embodiments, the alkoxy carboxylate can be a branched or unbranched C6-C30:PO(30-40):EO(25-35)-carboxylate. In certain embodiments, the alkoxy carboxylate can be a branched or unbranched C6-C12:PO(30-40):EO(25-35)-carboxylate. In certain embodiments, the alkoxy carboxylate can be a branched or unbranched C6-C30:EO(8-30)-carboxylate.

An “alkoxy sulfate surfactant” or “alkoxy sulfate” refers to a surfactant having an alkyl or aryl attached to one or more alkoxylene groups (typically —CH2-CH(ethyl)-O—, —CH2-CH(methyl)-O—, or —CH2-CH2-O—) which, in turn is attached to —SO3- or acid or salt thereof including metal cations such as sodium. In some embodiment, the alkoxy sulfate surfactant has the formula R-(BO)e-(PO)f-(EO)g-SO3- or acid or salt (including metal cations such as sodium) thereof, wherein R is C6-C32 alkyl, BO is —CH2-CH(ethyl)-O—, PO is —CH2-CH(methyl)-O—, and EO is —CH2-CH2-O—. The symbols e, f and g are integers from 0 to 50 wherein at least one is not zero.

In embodiments, the alkoxy sulfate surfactant can be an aryl alkoxy sulfate surfactant. The aryl alkoxy surfactant can be an alkoxy surfactant having an aryl attached to one or more alkoxylene groups (typically —CH2-CH(ethyl)-O—, —CH2-CH(methyl)-O—, or —CH2-CH2-O—) which, in turn is attached to —SO3- or acid or salt thereof including metal cations such as sodium.

An “alkyl sulfonate surfactant” or “alkyl sulfonate” refers to a compound that includes an alkyl group (e.g., a branched or unbranched C6-C32 alkyl group) attached to —SO3- or acid or salt thereof including metal cations such as sodium.

An “aryl sulfate surfactant” or “aryl sulfate” refers to a compound having an aryl group attached to —O—SO3- or acid or salt thereof including metal cations such as sodium. An “aryl sulfonate surfactant” or “aryl sulfonate” refers to a compound having an aryl group attached to —SO3- or acid or salt thereof including metal cations such as sodium. In some cases, the aryl group can be substituted, for example, with an alkyl group (an alkyl aryl sulfonate).

An “internal olefin sulfonate,” “isomerized olefin sulfonate,” or “IOS” refers to an unsaturated hydrocarbon compound comprising at least one carbon-carbon double bond and at least one SO3- group, or a salt thereof. As used herein, a “C20-C28 internal olefin sulfonate,” “a C20-C28 isomerized olefin sulfonate,” or “C20-C28 IOS” refers to an IOS, or a mixture of IOSs with an average carbon number of 20 to 28, or of 23 to 25. The C20-C28 IOS may include at least 80% of IOS with carbon numbers of 20 to 28, at least 90% of IOS with carbon numbers of 20 to 28, or at least 99% of IOS with carbon numbers of 20 to 28. As used herein, a “C15-C18 internal olefin sulfonate,” “C15-C18 isomerized olefin sulfonate,” or “C15-C18 IOS” refers to an IOS or a mixture of IOSs with an average carbon number of 15 to 18, or of 16 to 17. The C15-C18 IOS may include at least 80% of IOS with carbon numbers of 15 to 18, at least 90% of IOS with carbon numbers of 15 to 18, or at least 99% of IOS with carbon numbers of 15 to 18. The internal olefin sulfonates or isomerized olefin sulfonates may be alpha olefin sulfonates, such as an isomerized alpha olefin sulfonate. The internal olefin sulfonates or isomerized olefin sulfonates may also include branching. In certain embodiments, C15-18 IOS may be added to the single-phase liquid surfactant package when the LPS injection fluid is intended for use in high temperature unconventional subterranean formations, such as formations above 130° F. (approximately 55° C.). The IOS may be at least 20% branching, 30% branching, 40% branching, 50% branching, 60% branching, or 65% branching. In some embodiments, the branching is between 20-98%, 30-90%, 40-80%, or around 65%. Examples of internal olefin sulfonates and the methods to make them are found in U.S. Pat. No. 5,488,148, U.S. Patent Application Publication 2009/0112014, and SPE 129766, all incorporated herein by reference.

In embodiments, the anionic surfactant can be a disulfonate, alkyldiphenyloxide disulfonate, mono alkyldiphenyloxide disulfonate, di alkyldiphenyloxide disulfonate, or a di alkyldiphenyloxide monosulfonate, where the alkyl group can be a C6-C36 linear or branched alkyl group. In embodiments, the anionic surfactant can be an alkylbenzene sulfonate or a dibenzene disufonate. In embodiments, the anionic surfactant can be benzenesulfonic acid, decyl(sulfophenoxy)-disodium salt; linear or branched C6-C36 alkyl:PO(0-65):EO(0-100) sulfate; or linear or branched C6-C36 alkyl:PO(0-65):EO(0-100) carboxylate. In embodiments, the anionic surfactant is an isomerized olefin sulfonate (C6-C30), internal olefin sulfonate (C6-C30) or internal olefin disulfonate (C6-C30). In some embodiments, the anionic surfactant is a Guerbet-PO(0-65)-EO(0-100) sulfate (Guerbet portion can be C6-C36). In some embodiments, the anionic surfactant is a Guerbet-PO(0-65)-EO(0-100) carboxylate (Guerbet portion can be C6-C36). In some embodiments, the anionic surfactant is alkyl PO(0-65) and EO(0-100) sulfonate: where the alkyl group is linear or branched C6-C36. In some embodiments, the anionic surfactant is a sulfosuccinate, such as a dialkylsulfosuccinate. In some embodiments, the anionic surfactant is an alkyl aryl sulfonate (AAS) (e.g. an alkyl benzene sulfonate (ABS)), a C10-C30 internal olefin sulfate (IOS), a petroleum sulfonate, or an alkyl diphenyl oxide (di)sulfonate.

In some examples, the anionic surfactant can include a surfactant defined by the formula below:

R¹—R²—R³

wherein R¹ includes a branched or unbranched, saturated or unsaturated, cyclic or non-cyclic, hydrophobic carbon chain having 6-32 carbon atoms and an oxygen atom linking R¹ and R²; R² includes an alkoxylated chain including at least one oxide group selected from the group consisting of ethylene oxide, propylene oxide, butylene oxide, and combinations thereof; and R³ includes a branched or unbranched hydrocarbon chain including 2-12 carbon atoms and from 2 to 5 carboxylate groups.

In some examples, the anionic surfactant can include a surfactant defined by the formula below:

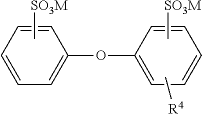

wherein R4 is a branched or unbranched, saturated or unsaturated, cyclic or non-cyclic, hydrophobic carbon chain having 6-32 carbon atoms; and M represents a counterion (e.g., Na+, K+). In some embodiments, R⁴ is a branched or unbranched, saturated or unsaturated, cyclic or non-cyclic, hydrophobic carbon chain having 6-16 carbon atoms.

In some embodiments, the surfactant can have a concentration within the liquid formulation including the miscible solvent of at least 1% by weight (e.g., at least 5%, at least 10%, or at least 15%).

In some embodiments, the surfactant can have a concentration within the liquid formulation including the miscible solvent of 20% or less by weight (e.g., 15% or less, 10% or less, or 5% or less).

The surfactant can have a concentration within the liquid formulation including the miscible solvent ranging from any of the minimum values described above to any of the maximum values described above. For example, in some embodiments, the surfactant can have a concentration within the liquid formulation including the miscible solvent of from 1% to 20% by weight (e.g., from 1% to 15%, from 1% to 10%, from 5% to 20%, from 5% to 15%, from 5% to 10%, from 10% to 20%, from 10% to 15%, or from 15% to 20%).

In some embodiments, the nonionic surfactant can have a concentration within the liquid formulation including the miscible solvent of from 0.1% to 0.25% by weight (e.g., from 0.1% to 0.125%, from 0.1% to 0.2%, from 0.125% to 0.25%, from 0.125% to 0.2%, or from 0.2% to 0.25%). In some embodiments, the anionic surfactant can have a concentration within the liquid formulation including the miscible solvent of from 0.1% to 0.25% by weight (e.g., from 0.1% to 0.125%, from 0.1% to 0.2%, from 0.125% to 0.25%, from 0.125% to 0.2%, or from 0.2% to 0.25%).

In some embodiments, the surfactants can be present in the liquid formulation including the miscible solvent in a weight ratio of non-ionic surfactant to anionic surfactant of from 0.5 to 5 (e.g., from 0.5 to 4, from 0.5 to 3, from 0.5 to 2, from 0.5 to 1, from 1 to 5, from 1 to 4, from 1 to 3, from 1 to 2, from 2 to 5, from 2 to 4, from 2 to 3, from 3 to 4, from 3 to 5, or from 4 to 5).

In some embodiments, the liquid formulation including the miscible solvent can include a non-ionic surfactant and an anionic surfactant (e.g., a sulfonate or disulfonate). In some embodiments, the liquid formulation including the miscible solvent can include a non-ionic surfactant and two or more anionic surfactants (e.g., a sulfonate or disulfonate and a carboxylate). In some embodiments, the liquid formulation including miscible solvent can include a non-ionic surfactant (e.g., a C6-C16 alkyl phenol ethoxylate, or a C6-C16:PO(0-25):EO(0-25), such as a C9-C11 ethoxylated alcohol, a C13 ethoxylated alcohol, a C6-C10 ethoxylated propoxylated alcohol, or a C10-C14 ethoxylated Guerbet alcohol) and a sulfonate surfactant (e.g., a C10-16 disulfonate, or a C16-28 IOS). In some embodiments, the miscible solvent formulation can include a non-ionic surfactant (e.g., a C6-C16 alkyl phenol ethoxylate, or a C6-16:PO(0-25):EO(0-25), such as a C9-C11 ethoxylated alcohol, a C13 ethoxylated alcohol, a C6-C10 ethoxylated propoxylated alcohol, or a C10-C14 ethoxylated Guerbet alcohol), a sulfonate surfactant (e.g., a C10-16 disulfonate, or a C16-28 IOS), and a carboxylate surfactant (e.g., a C10-16 alkyl polyglucoside carboxylate or a C22-C36 Guerbet alkoxylated carboxylate).

Specific example embodiments include formulations including surfactants and co-surfactants in the table below.

| | Surfactants and Co-Surfactants |
|---|---|
| | in formulation |
| Formulation | (in weight percent) |
| 1 | 0.09% alkoxylated C6-C16 alcohol |
| | 0.06% disulfonate |
| 2 | 0.1% alkoxylated C6-C16 alcohol |
| | 0.1% carboxylate |
| | 0.1% disulfonate |
| 3 | 0.15% alkoxylated C6-C16 alcohol |
| | 0.075% carboxylate |
| | 0.075% disulfonate |
| 4 | 0.2% alkoxylated C6-C16 alcohol |
| | 0.1% carboxylate |
| 5 | 0.2% alkoxylated C6-C16 alcohol |
| | 0.033% carboxylate |
| | 0.066% disulfonate |
| 6 | 0.2% alkoxylated C6-C16 alcohol |
| | 0.033% carboxylate |
| | 0.066% disulfonate |
| 7 | 0.2% alkoxylated C6-C16 alcohol |
| | 0.05% carboxylate |
| | 0.05% olefin sulfonate |
| 8 | 0.15% alkoxylated C6-C16 alcohol |
| | 0.05% carboxylate |
| | 0.05% olefin sulfonate |
| | 0.05% alkyl polyglucoside |
| 9 | 0.1% alkoxylated C6-C16 alcohol |
| | 0.05% carboxylate |
| | 0.05% olefin sulfonate |
| | 0.1% alkyl polyglucoside |
| 10 | 0.15% alkoxylated C6-C16 alcohol |
| | 0.07% carboxylate |
| | 0.03% olefin sulfonate |
| | 0.1% alkyl polyglucoside |
| 11 | 0.1% alkoxylated C6-C16 alcohol |
| | 0.04% carboxylate |
| | 0.05% olefin sulfonate |
| | 0.03% disulfonate |
| | 0.1% alkyl polyglucoside |
| 12 | 0.1% alkoxylated C6-C16 alcohol |
| | 0.04% carboxylate |
| | 0.06% disulfonate |
| | 0.1% alkyl polyglucoside |
| 13 | 0.15% alkoxylated C6-C16 alcohol |
| | 0.15% alkoxylated alkylphenol |
| | 0.1% olefin sulfonate |
| | 0.1% Guerbet alkoxylated carboxylate |
| 14 | 0.125% alkoxylated C6-C16 alcohol |
| | 0.175% alkoxylated alkylphenol |
| | 0.1% olefin sulfonate |
| | 0.1% Guerbet alkoxylated carboxylate |
| 15 | 0.1% alkoxylated C6-C16 alcohol |
| | 0.2% alkoxylated alkylphenol |
| | 0.1% olefin sulfonate |
| | 0.1% Guerbet alkoxylated carboxylate |
| 16 | 0.12% alkoxylated C6-C16 alcohol |
| | 0.22% alkoxylated alkylphenol |
| | 0.08% olefin sulfonate |
| | 0.08% Guerbet alkoxylated carboxylate |
| 17 | 0.15% alkoxylated C6-C16 alcohol |
| | 0.15% alkoxylated alkylphenol |
| | 0.08% olefin sulfonate |
| | 0.06% Guerbet alkoxylated carboxylate |
| | 0.06% carboxylate |
| 18 | 0.15% alkoxylated C6-C16 alcohol |
| | 0.15% alkoxylated alkylphenol |
| | 0.05% olefin sulfonate |
| | 0.1% Guerbet alkoxylated carboxylate |
| | 0.05% disulfonate |
| 19 | 0.5% olefin sulfonate |
| | 0.5% Guerbet alkoxylated carboxylate |
| | 0.55% glycosides or glucosides |
| 20 | 0.5% olefin sulfonate |
| | 0.5% Guerbet alkoxylated carboxylate |
| | 0.5% glycosides or glucosides |
| | 0.25% alkoxylated C6-C16 alcohol |
| 21 | 0.5% olefin sulfonate |
| | 0.5% Guerbet alkoxylated carboxylate |
| | 0.5% glycosides or glucosides |
| | 0.5% alkoxylated C6-C16 alcohol |
| 22 | 0.5% olefin sulfonate |
| | 0.5% Guerbet alkoxylated carboxylate |
| | 1% glycosides or glucosides |
| | 0.5% alkoxylated C6-C16 alcohol |
| 23 | 0.05% olefin sulfonate |
| | 0.05% Guerbet alkoxylated carboxylate |
| | 0.05% glycosides or glucosides |
| | 0.05% alkoxylated C6-C16 alcohol |
| 24 | 0.075% glycosides or glucosides |
| | 0.075% alkoxylated C6-C16 alcohol |
| 25 | 0.1% alkoxylated C6-C16 alcohol |
| | 0.05% disulfonate |
| 26 | 0.1% alkoxylated C6-C16 alcohol |
| | 0.05% disulfonate |
| | 0.03% hydroxyalkyl alkylammonium chloride |
| 27 | 0.03% olefin sulfonate |
| | 0.04% Guerbet alkoxylated carboxylate |
| | 0.08% glycosides or glucosides |
| | 0.05% alkoxylated C6-C16 alcohol |
| 28 | 0.4% olefin sulfonate |
| | 0.4% Guerbet alkoxylated carboxylate |
| | 0.7% glycosides or glucosides |
| | 0.5% alkoxylated C6-C16 alcohol |
| 29 | 0.05% olefin sulfonate |
| | 0.1% glycosides or glucosides |
| | 0.05% alkoxylated C6-C16 alcohol |
| 30 | 0.05% olefin sulfonate |
| | 0.1% alkyl polyglucoside |
| | 0.05% alkoxylated C6-C16 alcohol |
| 31 | 0.05% olefin sulfonate |
| | 0.1% glycosides or glucosides |
| | 0.05% alkoxylated C6-C16 alcohol |
| 32 | 0.05% olefin sulfonate |
| | 0.1% alkyl polyglucoside |
| | 0.05% alkoxylated C6-C16 alcohol |
| 33 | 0.05% olefin sulfonate |
| | 0.1% alkyl polyglucoside |
| | 0.05% alkoxylated C6-C16 alcohol |
| 34 | 0.05% olefin sulfonate |
| | 0.05% glycosides or glucosides |
| | 0.05% alkoxylated C6-C16 alcohol |
| | 0.05% carboxylate |
| 35 | 0.05% olefin sulfonate |
| | 0.05% glycosides or glucosides |
| | 0.05% alkoxylated C6-C16 alcohol |
| | 0.05% carboxylate |
| 36 | 0.05% olefin sulfonate |
| | 0.05% alkyl polyglucoside |
| | 0.05% alkoxylated C6-C16 alcohol |
| 37 | 0.06% olefin sulfonate |
| | 0.05% alkyl polyglucoside |
| | 0.04% alkoxylated C6-C16 alcohol |
| 38 | 0.04% olefin sulfonate |
| | 0.08% glycosides or glucosides |
| | 0.05% alkoxylated C6-C16 alcohol |
| | 0.03% disulfonate |
| 39 | 0.035% olefin sulfonate |
| | 0.075% glycosides or glucosides |
| | 0.05% alkoxylated C6-C16 alcohol |
| | 0.04% disulfonate |
| 40 | 0.035% olefin sulfonate |
| | 0.07% glycosides or glucosides |
| | 0.045% alkoxylated C6-C16 alcohol |
| | 0.05% disulfonate |
| 41 | 0.1% alkoxylated C6-C16 alcohol |
| | 0.1% disulfonate |
| 42 | 0.25% Guerbet alkoxylated carboxylate |
| | 0.25% olefin sulfonate |
| | 0.5% glycosides or glucosides |
| | 0.5% co-solvent |
| 43 | 0.075% alkoxylated C12-C22 alcohol |
| | 0.075% disulfonate |
| 44 | 0.075% alkoxylated C6-C16 Guerbet alcohol |
| | 0.075% disulfonate |
| 45 | 0.075% alkoxylated C6-C16 Guerbet alcohol |
| | 0.075% disulfonate |
| 46 | 0.075% alkoxylated C6-C16 alcohol |
| | 0.075% disulfonate |
| 47 | 0.075% disulfonate |
| | 0.075% alkoxylated C6-C16 alcohol |
| 48 | 0.0625% disulfonate |
| | 0.0875% alkoxylated C6-C16 alcohol |
| 49 | 0.055% disulfonate |
| | 0.095% alkoxylated C6-C16 alcohol |
| 50 | 0.075% disulfonate |
| | 0.075% alkoxylated C6-C16 alcohol |
| 51 | 1% alkoxylated C6-C16 alcohol |
| | 0.5% disulfonate |
| 52 | 1% alkoxylated C6-C16 alcohol |
| 53 | 1% alkoxylated C6-C16 alcohol |
| | 2.25% sulfosuccinate |
| 54 | 0.25% Guerbet alkoxylated carboxylate |
| | 1% alkoxylated C6-C16 alcohol |
| | 2.25% sulfosuccinate |
| 55 | 0.25% Guerbet alkoxylated carboxylate |
| | 1% alkoxylated alkylphenol |
| | 2.25% sulfosuccinate |
| 56 | 0.25% Guerbet alkoxylated carboxylate |
| | 1% alkoxylated C6-C16 alcohol |
| 57 | 0.25 Guerbet alkoxylated carboxylate |
| | 1% alkoxylated alkylphenol |
| 58 | 0.65% carboxylate |
| | 0.35% alkoxylated C6-C16 alcohol |
| 59 | 0.325% carboxylate |
| | 0.925% alkoxylated C6-C16 alcohol |
| 60 | 0.25% olefin sulfonate |
| | 1.0% alkoxylated C6-C16 alcohol |
| 61 | 0.15% olefin sulfonate |
| | 0.2% Guerbet alkoxylated carboxylate |
| | 0.92% carboxylate |
| 62 | 0.65% carboxylate |
| | 0.35% second carboxylate |
| 63 | 0.65% carboxylate |
| | 0.35% alkoxylated C6-C16 alcohol |
| | 1% olefin sulfonate |
| 64 | 1% alkoxylated alcohol |
| | 1% olefin sulfonate |
| 65 | 0.5% alkoxylated alcohol |
| | 0.5% olefin sulfonate |
| | 0.25% carboxylate |
| 66 | 0.6% co-solvent |
| | 0.6% olefin sulfonate |
| 67 | 0.6% co-solvent |
| | 0.3% disulfonate |
| | 0.3% olefin sulfonate |
| 68 | 0.6% Guerbet alkoxylated carboxylate |
| | 0.6% disulfonate |
| 69 | 0.6% co-solvent |
| | 0.4% disulfonate |
| | 0.2% olefin sulfonate |
| 70 | 0.5% alkoxylated C6-C16 alcohol |
| | 0.4% disulfonate |
| | 0.3% olefin sulfonate |
| 71 | 1% alkoxylated C6-C16 alcohol |
| 72 | 0.9% alkoxylated C6-C16 alcohol |
| | 0.6% disulfonate |
| 73 | 0.4% alkoxylated C6-C16 alcohol |
| | 0.35% disulfonate |
| | 0.25% olefin sulfonate |
| | 0.5% co-solvent |
| 74 | 0.25% Guerbet alkoxylated carboxylate |
| | 0.5% alkoxylated C6-C16 alcohol |
| | 0.35% disulfonate |
| | 0.15% olefin sulfonate |
| | 0.35% co-solvent |
| 75 | 0.25% Guerbet alkoxylated carboxylate |
| | 0.25% alkoxylated C6-C16 alcohol |
| | 0.25% olefin sulfonate |
| | 0.25% co-solvent |
| 76 | 0.25% Guerbet alkoxylated carboxylate |
| | 0.25% alkoxylated C6-C16 alcohol |
| | 0.25% olefin sulfonate |
| | 0.25% alkoxylated alcohol |
| 77 | 0.25% Guerbet alkoxylated carboxylate |
| | 0.35% olefin sulfonate |
| | 0.5% alkoxylated alcohol |
| 78 | 0.25% Guerbet alkoxylated carboxylate |
| | 0.25% alkoxylated C6-C16 alcohol |
| | 0.15% olefin sulfonate |
| | 0.1% disulfonate |
| | 0.25% co-solvent |
| 79 | 0.25% Guerbet alkoxylated carboxylate |
| | 0.25% alkoxylated C6-C16 alcohol |
| | 0.25% olefin sulfonate |
| | 0.25% glycosides or glucosides |
| | 0.25% co-solvent |
| | 0.15% disulfonate |
| 80 | 0.25% Guerbet alkoxylated carboxylate |
| | 0.25% olefin sulfonate |
| | 0.5% glycosides or glucosides |
| | 0.25% co-solvent |
| 81 | 0.15% alkoxylated C12-C22 alcohol |
| 82 | 0.075% alkoxylated C12-C22 alcohol |
| | 0.075% disulfonate |
| 83 | 0.075% alkoxylated C12-C22 alcohol |
| | 0.075% disulfonate |
| 84 | 0.075% alkoxylated C12-C22 alcohol |
| | 0.075% alkoxylated C6-C16 Guerbet alcohol |
| 85 | 0.15% alkoxylated C6-C16 Guerbet alcohol |
| 86 | 0.075% alkoxylated C6-C16 Guerbet alcohol |
| | 0.075% disulfonate |
| 87 | 0.075% alkoxylated C6-C16 Guerbet alcohol |
| | 0.075% disulfonate |
| | 0.05% co-solvent |
| 88 | 0.1% alkoxylated C6-C16 alcohol |
| | 0.05% disulfonate |
| 89 | 1% alkoxylated C6-C16 alcohol |
| | 0.5% disulfonate |
| 90 | 0.075% alkoxylated C6-C16 Guerbet alcohol |
| | 0.075% disulfonate |
| 91 | 0.075% alkoxylated C6-C16 Guerbet alcohol |
| | 0.125% disulfonate |
| 92 | 0.075% alkoxylated C12-C22 alcohol |
| | 0.125% disulfonate |
| 93 | 0.075% alkoxylated C12-C22 alcohol |
| | 0.075% disulfonate |
| 94 | 0.075% alkoxylated C6-C16 Guerbet alcohol |
| | 0.075% disulfonate |
| 95 | 0.1% alkoxylated C6-C16 Guerbet alcohol |
| | 0.05% disulfonate |
| 96 | 0.075% alkoxylated C6-C16 Guerbet alcohol |
| | 0.075% disulfonate |
| 97 | 0.075% alkoxylated C6-C16 alcohol |
| | 0.075% disulfonate |
| 98 | 0.075% alkoxylated C6-C16 Guerbet alcohol |
| | 0.075% disulfonate |
| 99 | 0.1% alkoxylated C6-C16 alcohol |
| | 0.05% disulfonate |
| 100 | 0.09% alkoxylated C6-C16 alcohol |
| | 0.06% disulfonate |
| 101 | 0.1% alkoxylated C6-C16 alcohol |
| | 0.1% disulfonate |
| | 0.1% Guerbet alkoxylated carboxylate |
| 102 | 0.1% alkoxylated C6-C16 alcohol |
| | 0.1% disulfonate |
| 103 | 0.65% Guerbet alkoxylated carboxylate |
| | 0.35% olefin sulfonate |
| | 0.33% alkoxylated alkylphenol |
| | 0.5% co-solvent |
| | 0.25% second co-solvent |
| 104 | 0.075% alkoxylated C6-C16 alcohol |
| | 0.075% benzenesulfonic acid, |
| | decyl(sulfophenoxy)-disodium salt |
| 105 | 0.15% alkoxylated C6-C16 alcohol |
| | 0.05% benzenesulfonic acid, |
| | decyl(sulfophenoxy)-disodium salt |

In some cases, the subterranean formation can include fractures. These existing fractures can be naturally occurring fractures present within a formation. For example, in some embodiments, the formation can include naturally fractured carbonate or naturally fractured sandstone. The presence or absence of naturally occurring fractures within a subterranean formation can be assessed using standard methods known in the art, including seismic surveys, geology, outcrops, cores, logging, reservoir characterization including preparing grids, etc. In other embodiments, the formation can include fractures generated by a fracturing operation.

In some embodiments, the subterranean formation can have a temperature of at least 75° F. (e.g., at least 80° F., at least 85° F., at least 90° F., at least 95° F., at least 100° F., at least 105° F., at least 110° F., at least 115° F., at least 120° F., at least 125° F., at least 130° F., at least 135° F., at least 140° F., at least 145° F., at least 150° F., at least 155° F., at least 160° F., at least 165° F., at least 170° F., at least 175° F., at least 180° F., at least 190° F., at least 200° F., at least 205° F., at least 210° F., at least 215° F., at least 220° F., at least 225° F., at least 230° F., at least 235° F., at least 240° F., at least 245° F., at least 250° F., at least 255° F., at least 260° F., at least 265° F., at least 270° F., at least 275° F., at least 280° F., at least 285° F., at least 290° F., at least 295° F., at least 300° F., at least 305° F., at least 310° F., at least 315° F., at least 320° F., at least 325° F., at least 330° F., at least 335° F., at least 340° F., or at least 345° F.). In some embodiments, the subterranean formation can have a temperature of 350° F. or less (e.g., 345° F. or less, 340° F. or less, 335° F. or less, 330° F. or less, 325° F. or less, 320° F. or less, 315° F. or less, 310° F. or less, 305° F. or less, 300° F. or less, 295° F. or less, 290° F. or less, 285° F. or less, 280° F. or less, 275° F. or less, 270° F. or less, 265° F. or less, 260° F. or less, 255° F. or less, 250° F. or less, 245° F. or less, 240° F. or less, 235° F. or less, 230° F. or less, 225° F. or less, 220° F. or less, 215° F. or less, 210° F. or less, 205° F. or less, 200° F. or less, 195° F. or less, 190° F. or less, 185° F. or less, 180° F. or less, 175° F. or less, 170° F. or less, 165° F. or less, 160° F. or less, 155° F. or less, 150° F. or less, 145° F. or less, 140° F. or less, 135° F. or less, 130° F. or less, 125° F. or less, 120° F. or less, 115° F. or less, 110° F. or less, 105° F. or less, 100° F. or less, 95° F. or less, 90° F. or less, 85° F. or less, or 80° F. or less).

The subterranean formation can have a temperature ranging from any of the minimum values described above to any of the maximum values described above. For example, in some embodiments, the subterranean formation can have a temperature of from 75° F. to 350° F. (approximately 24° C. to 176° C., from 130° F. to 250° F. (approximately 54° C. to 121° C.), from 100° F. to 250° F. (approximately 38° C. to 121° C.), from 150° F. to 180° F. (approximately 66° C. to 82° C.), from 150° F. to 250° F. (approximately 66° C. to 121° C.), from 150° F. to 250° F. (approximately 66° C. to 121° C.), from 110° F. to 350° F. (approximately 43° C. to 176° C.), from 110° F. to 150° F. (approximately 43° C. to 66° C.), from 150° F. to 200° F. (approximately 66° C. to 93° C.), from 200° F. to 250° F. (approximately 93° C. to 121° C.), from 250° F. to 300° F. (approximately 121° C. to 149° C.), from 300° F. to 350° F. (approximately 149° C. to 176° C.), from 110° F. to 240° F. (approximately 43° C. to 116° C.), or from 240° F. to 350° F. (approximately 116° C. to 176° C.).

In some embodiments, the salinity of subterranean formation can be at least 5,000 ppm TDS (e.g., at least 25,000 ppm TDS, at least 50,000 ppm TDS, at least 75,000 ppm TDS, at least 100,000 ppm TDS, at least 125,000 ppm TDS, at least 150,000 ppm TDS, at least 175,000 ppm TDS, at least 200,000 ppm TDS, at least 225,000 ppm TDS, at least 250,000 ppm TDS, or at least 275,000 ppm TDS). In some embodiments, the salinity of subterranean formation can be 300,000 ppm TDS or less (e.g., 275,000 ppm TDS or less, 250,000 ppm TDS or less, 225,000 ppm TDS or less, 200,000 ppm TDS or less, 175,000 ppm TDS or less, 150,000 ppm TDS or less, 125,000 ppm TDS or less, 100,000 ppm TDS or less, 75,000 ppm TDS or less, 50,000 ppm TDS or less, or 25,000 ppm TDS or less).

The salinity of subterranean formation can range from any of the minimum values described above to any of the maximum values described above. For example, in some embodiments, the salinity of subterranean formation can be from 5,000 ppm TDS to 300,000 ppm TDS (e.g., from 5,000 ppm TDS to 300,000 ppm TDS, from 30,000 ppm TDS to 300,000 ppm TDS, from 30,000 ppm TDS to 220,000 ppm TDS, or from 100,000 ppm to 300,000 ppm TDS).

In some embodiments, the subterranean formation can be oil-wet. In some embodiments, the subterranean formation can be water-wet. In some embodiments, the subterranean formation can be mixed-wet.

In some embodiments, the miscible solvent can be introduced at a wellhead pressure of at least 200 PSI (e.g., at least 250 PSI, at least 500 PSI, at least 750 PSI, at least 1000 PSI, at least 1500 PSI, at least 2000 PSI, at least 2500 PSI, at least 3000 PSI, at least 3500 PSI, at least 4000 PSI, at least 4500 PSI, at least 5000 PSI, at least 5500 PSI, at least 6000 PSI, at least 6500 PSI, at least 7000 PSI, at least 7500 PSI, at least 8000 PSI, at least 8500 PSI, at least 9000 PSI, at least 9500 PSI). In some embodiments, the miscible solvent can be introduced at a wellhead pressure of 10,000 PSI or less (e.g., 9,000 PSI or less, 8,000 PSI or less, 7,000 PSI or less, 6,000 PSI or less, 5,000 PSI or less, 4,000 PSI or less, 3,000 PSI or less, 2,000 PSI or less, 1,000 PSI or less, 500 PSI or less, 250 PSI or less).

The liquid formulation including the miscible solvent can be introduced at a wellhead pressure ranging from any of the minimum values described above to any of the maximum values described above. For example, in some embodiments, liquid formulation including the miscible solvent can be introduced at a wellhead pressure of from 200 PSI to 10,000 PSI (e.g. from 200 PSI to 9,000 PSI, from 200 PSI to 8,000 PSI, from 200 PSI to 7,000 PSI, from 200 PSI to 6,000 PSI, from 200 PSI to 5,000 PSI, from 200 PSI to 4,000 PSI, from 200 PSI to 3,000 PSI, from 200 PSI to 2,000 PSI, from 200 PSI to 1,000 PSI, from 200 PSI to 500 PSI, from 500 PSI to 10,000 PSI, from 500 PSI to 9,000 PSI, from 500 PSI to 8,000 PSI, from 500 PSI to 7,000 PSI, from 500 PSI to 6,000 PSI, from 500 PSI to 5,000 PSI, from 500 PSI to 4,000 PSI, from 500 PSI to 3,000 PSI, from 500 PSI to 2,000 PSI, from 500 PSI to 1,000 PSI, from 1000 PSI to 10,000 PSI, from 1000 PSI to 9,000 PSI, from 1000 PSI to 8,000 PSI, from 1,000 PSI to 7,000 PSI, from 1,000 PSI to 6,000 PSI, from 1,000 PSI to 5,000 PSI, from 1,000 PSI to 4,000 PSI, from 1,000 PSI to 3,000 PSI, from 1,000 PSI to 2,000 PSI, from 2000 PSI to 10,000 PSI, from 2,000 PSI to 9,000 PSI, from 2,000 PSI to 8,000 PSI, from 2,000 PSI to 7,000 PSI, from 2,000 PSI to 6,000 PSI, from 2,000 PSI to 5,000 PSI, from 2,000 PSI to 4,000 PSI, from 2,000 PSI to 3,000 PSI, from 3,000 PSI to 10,000 PSI, from 3,000 PSI to 9,000 PSI, from 3,000 PSI to 8,000 PSI, from 3,000 PSI to 7,000 PSI, from 3,000 PSI to 6,000 PSI, from 3,000 PSI to 5,000 PSI, from 3,000 PSI to 4,000 PSI, from 4,000 PSI to 10,000 PSI, from 4,000 PSI to 9,000 PSI, from 4,000 PSI to 8,000 PSI, from 4,000 PSI to 7,000 PSI, from 4,000 PSI to 6,000 PSI, from 4,000 PSI to 5,000 PSI, from 5,000 PSI to 10,000 PSI, from 5,000 PSI to 9,000 PSI, from 5,000 PSI to 8,000 PSI, from 5,000 PSI to 7,000 PSI, from 5,000 PSI to 6,000 PSI, from 6,000 PSI to 10,000 PSI, from 6,000 PSI to 9,000 PSI, from 6,000 PSI to 8,000 PSI, from 6,000 PSI to 7,000 PSI, from 7,000 PSI to 10,000 PSI, from 7,000 PSI to 9,000 PSI, from 7,000 PSI to 8,000 PSI, from 8,000 PSI to 10,000 PSI, from 8,000 PSI to 9,000 PSI, from 9,000 PSI to 10,000 PSI).

In some embodiments, the hydrocarbons present within the subterranean formation can include light oil. In some embodiments, the light oil can have an API gravity of at least 40 (e.g., at least 45, at least 50, or at least 55). In some embodiments, the light oil can have an API gravity of 60 or less (e.g., 55 or less, 50 or less, or 45 or less).

The light oil can have an API gravity ranging from any of the minimum values described above to any of the maximum values described above. For example, in some embodiments, the light oil can have an API gravity of from 40 to 60 (e.g., from 40 to 45, from 40 to 50, from 40 to 55, from 45 to 50, from 45 to 55, from 45 to 60, from 50 to 55, from 50 to 60, or from 55 to 60).

In some embodiments, the liquid formulation including the miscible solvent can be injected in an effective amount to reduce the viscosity of the hydrocarbons present within the subterranean formation by at least 1% (e.g., at least 5%, at least 10%, at least 20%, at least 30%, at least 40%, at least 50%, at least 60%, at least 70%, or at least 80%).

In some embodiments, the liquid formulation including the miscible solvent can be injected in an effective amount to reduce the viscosity of the hydrocarbons present within the subterranean formation by 90% or less (e.g., 80% or less, 70% or less, 60% or less, 50% or less, 40% or less, 30% or less, 20% or less, 10% or less, or 5% or less).

The liquid formulation including the miscible solvent can be injected in an effective amount to reduce the viscosity of the hydrocarbons present within the subterranean formation ranging from any of the minimum values described above to any of the maximum values described above. For example, in some embodiments, the liquid formulation including the miscible solvent can be injected in an effective amount to reduce the viscosity of the hydrocarbons present within the subterranean formation by from 1% to 90% (e.g., from 1% to 80%, from 1% to 70%, from 1% to 60%, from 1% to 50%, from 1% to 40%, from 1% to 30%, from 1% to 20%, from 1% to 10%, from 1% to 5%, from 5% to 90%, from 5% to 80%, from 5% to 70%, from 5% to 60%, from 5% to 50%, from 5% to 40%, from 5% to 30%, from 5% to 20%, from 5% to 10%, 10% to 90%, from 10% to 80%, from 10% to 70%, from 10% to 60%, from 10% to 50%, from 10% to 40%, from 10% to 30%, from 10% to 20%, 20% to 90%, from 20% to 80%, from 20% to 70%, from 20% to 60%, from 20% to 50%, from 20% to 40%, from 20% to 30%, 30% to 90%, from 30% to 80%, from 30% to 70%, from 30% to 60%, from 30% to 50%, from 30% to 40%, 40% to 90%, from 40% to 80%, from 40% to 70%, from 40% to 60%, from 40% to 50%, 50% to 90%, from 50% to 80%, from 50% to 70%, from 50% to 60%, 60% to 90%, from 60% to 80%, from 60% to 70%, 70% to 90%, from 70% to 80%, or from 80% to 90%).

In some embodiments, the liquid formulation including the miscible solvent can be injected in an effective amount to reduce the viscosity of the light oil present within the subterranean formation by at least 20% (e.g., at least 30%, at least 40%, or at least 50%).

In some embodiments, the liquid formulation including the miscible solvent can be injected in an effective amount to reduce the viscosity of the light oil present within the subterranean formation by 60% or less (e.g., 50% or less, 40% or less, or 30% or less).

The liquid formulation including the miscible solvent can be injected in an effective amount to reduce the viscosity of the light oil present within the subterranean formation ranging from any of the minimum values described above to any of the maximum values described above. For example, in some embodiments, the liquid formulation including the miscible solvent can be injected in an effective amount to reduce the viscosity of the hydrocarbons present within the subterranean formation by from 20% to 60% (e.g., from 20% to 50%, from 20% to 40%, from 20% to 30%, from 30% to 60%, from 30% to 50%, from 30% to 40%, from 40% to 60%, from 40% to 50%, or from 50% to 60%).

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1: Core Injection Test with a Mixture Including DME for Oil Recovery

### Material

Rock sample: reservoir shale and tight rock samples with a permeability of 20-500 nano Darcy and a porosity of 3-10% were used for this test. The rock sample dimension is ˜7 inches in length and 2 inches in diameter. A composite core was made to make a core length to fit the core holder.

Oil sample: reservoir oil taken from target shale and tight formation was used as the oil phase for this test. The received oil sample was a dead, light oil with a viscosity of 1-2 cp.

Water sample: synthetic formation brine from target shale and tight formation was used as injection brine and aqueous phase for making surfactant formulations.
Surfactant formulations: 0.15% by weight of Formulation 1 (C16-18-25EO and a disulfonate)
Formulation 2 (C16-18-25EO, C28-35PO-30EO, and a disulfonate), and
Formulation 3 (C11-15(30-50EO) and a disulfonate) were prepared to mix with DME. A formulation including 0.3% by weight Formulation 1 was prepared for use as a control to evaluate the effect of added DME.

DME: 5% DME was dissolved in the above surfactant formulations to prepare example DME formulations including DME in combination with one or more surfactants. A test protocol was used to mix the designated surfactant formulation with DME. After mixing, the solution was preserved at an ISCO pump with a pressure of 1000 psi.

Test temperature: all core injection tests are conducted a temperature of 167° F. (75° C.).

### Test Procedure

A reservoir core sample saturated with crude oil was mounted in a high-pressure core holder. An annular fracture was made around the core in order for the injected fluid not to be forced into the core (matrix) to drive oil. Instead, the injected fluid (brine or surfactant formulation or surfactant formulation with DME) was injected into the annular fracture and allowed to imbibe into the core (matrix) and recover oil over time. After the core was mounted, the core holder pressure was increased to 2000 psi and the core holder temperature was increased to 167° F. (75° C.). Then, injection brine, a surfactant formulation, or a surfactant formulation with DME was injected through the annular fracture. The core was soaked for 7 days to allow the injected brine, surfactant formulation, or surfactant formulation with DME solution imbibe into the core and recover oil over time. After the soaking step, the fluids were discharged from the fractures by injecting fresh brine, surfactant formulation, or surfactant formulation with DME solution. Then, the produced oil, aqueous phase, and DME were separated. Finally, the produced oil was measured. The injection and separation steps were repeated until no oil production was observed visually. The core injection test was stopped when no oil production was observed.

### Test Result

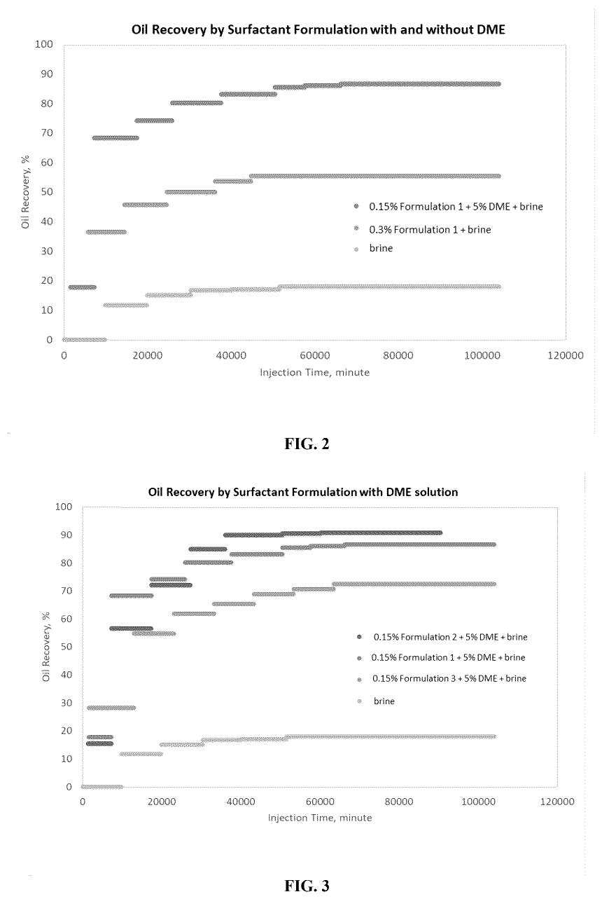

FIG. 2 shows the core injection test results obtained using brine, surfactant formulation 1, and surfactant formulation 1 with DME. The baseline oil recovery used formation brine as the injection water. The oil recovery using surfactant formulation 1 with DME was higher than with surfactant formulation 1 without DME, and brine, indicating that the incorporation of DME further boosted the oil recovery from shale and tight rock. FIG. 3 shows the core injection test result demonstrating that different surfactant formulations mixed with DME also provide for improved oil recovery performance.

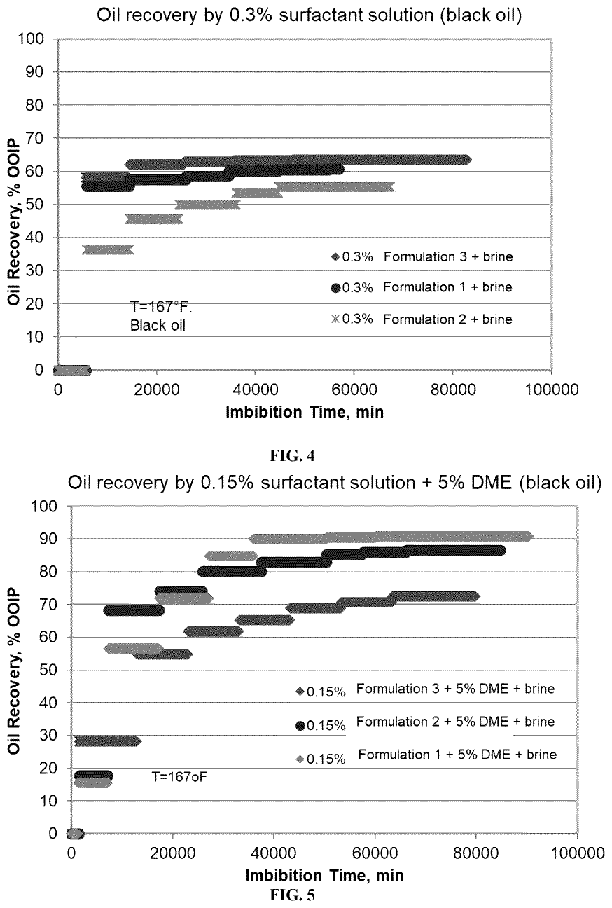

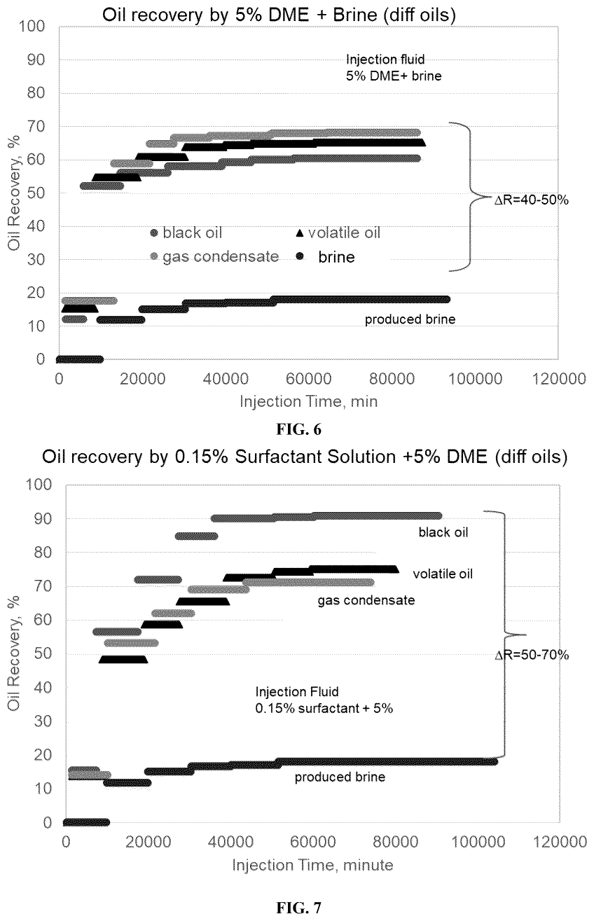

FIGS. 4 and 5 demonstrate that adding 5% DME in a surfactant solution (formulation 1, 2, or 3) results in oil recovery increased by more than 20%, quick oil production in early stage, and reduced amount of surfactant concentration by 50%. Based on the surfactant formulations tested Formulation 1 with DME gives the highest oil recovery uplift due to IFT reduction effect. FIGS. 6 and 7 show that in average, the oil recovery uplift by 5% DME injection is approximately 40-50%, however, the oil recovery uplift by 0.15% surfactant formulation and 5% DME is approximately 50-70%. Also, among the three kinds of oil tested, oil recovery uplift by 5% DME is similar; however, the oil recovery uplift by surfactant formulation and DME blends is dependent to oil composition. Black oil has the best performance.

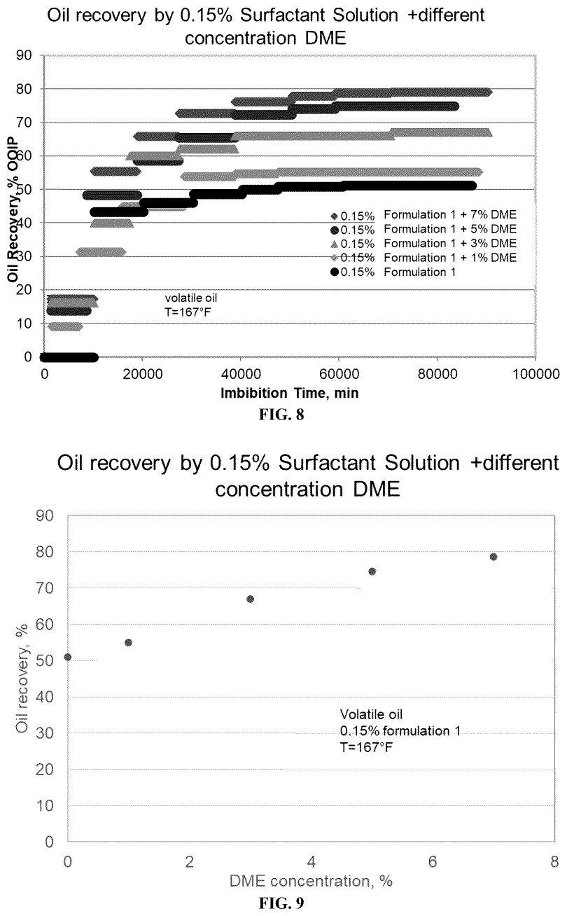

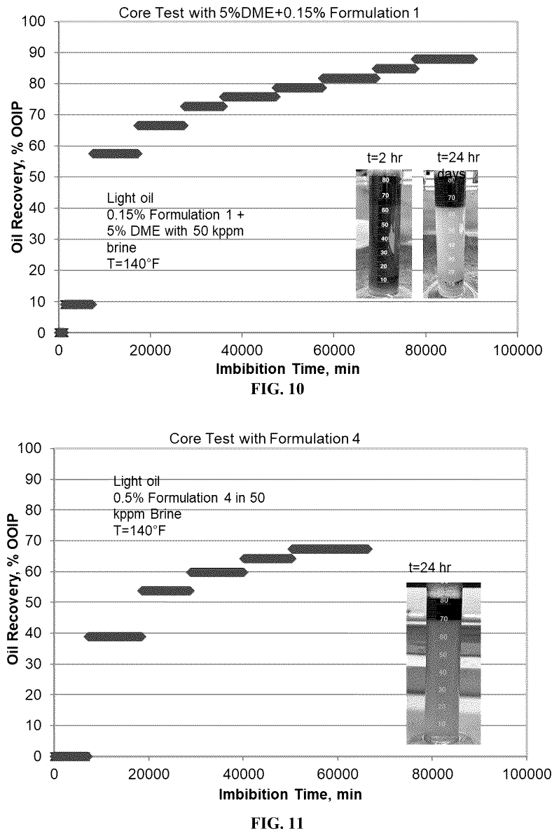

FIGS. 9 and 8 show that when surfactant concentration is fixed, the oil recovery by surfactant and DME increased with DME concentration and above 5% DME concentration the effect tends to be less significant. FIGS. 10 and 11 show that adding 5% DME in 0.15% Formulation 1 leads to further oil recovery uplift to 82%, which is about 14% higher than that for Formulation 4 (C12-C20 35PO:45EO). Further, Oil-water emulsion breaks in 48 hours.

### Example 2: Partitioning Coefficient Test for DME in Brine and Oil

To measure partitioning of the miscible solvent in contact with oil and brine for a particular chemical concentration, salinity of aqueous phase, oil type, temperature, and pressure.

### Equipment Used:

| | | | Pressure | Temperature |
|---|---|---|---|---|
| Item | Model | Material | (psi) | (F.) |
| Accumulator | ProFisc 220 | Titanium | 3,191 | −4 to 212 |
| Sapphire cell | Extratex SC700 | Hastelloy | 10,152 | 302 |
| | ½ | | | |
| Back pressure | Corelab-BPR- | Hastelloy/ | 10,000 | 350 |
| regulator (BPR) | 100 | SS | | |
| Pressure relief valve | Swagelock SS- | Stainless | 2,500 | na |
| | 4R3A | steel | | |
| Pump | Vindum | Hastelloy/ | 10,000 | na |
| | | SS | | |

### Experimental Procedure for Static Partitioning Test:

Load accumulator #1 with brine and accumulator #2 with oil. Apply vacuum to sapphire cell #1 and sapphire cell #2 on the loading side of the piston. Fill the opposite side with water or lab oil. Prepare loading loop with a known volume with liquid DME at room temperature (pressure >100 psi) to ensure a target concentration of DME when injected. Connect loading loop to sapphire cell #1 (vacuum side) and to accumulator #1. Connect the opposite side of the sapphire (water side) to BPR to keep pressure inside the cell at 150 psi. Then, displace DME from the loop with brine and inject into the sapphire cell #1. Isolate and disconnect the sapphire cell #1. Then, rock the cell until liquid DME and brine get properly mixed and homogenized. Equilibrate aqueous mix for a couple of hours. Connect the accumulator #2 with the sapphire cell #2, and the sapphire cell to the BPR. Then, inject oil into the sapphire cell #2. The volume of the injected oil is the one for the desired aqueous to oil ratio (i.e. 50/50 aqueous to oil by volume). Connect the sapphire cell #1 (DME in aqueous side) to the sapphire cell #2 (oil side) and inject DME in aqueous side to cell #2. The volume of the injected aqueous phase is the one for the desired aqueous to oil ratio. The pressure inside the sapphire cell # is controlled by BPR at 150 psi. Isolate and disconnect the sapphire cell #2. Then, rock the cell until liquid aqueous and oil get properly mixed. Let the cell equilibrate for 12 hours at room temperature (˜70° F.). Prepare a solution of 1:1 by volume of deionized water and methanol. Collect a sample of aqueous phase (DME in brine) from cell #2 and mix it with methanol solution in a volumetric proportion of 1:1. Measure DME concentration in aqueous mixture from previous step via gas chromatography (GC). Then, calculate partitioning of DME in between brine and oil phase, this is the partitioning coefficient.

$${k}_{DME} = \frac{{C}_{DME , Oil}}{{C}_{DME , Aq}}$$

KDME=DME partitioning coefficient; C_{DME,aq}=mass fraction of DME in aqueous phase at equilibrium; and C_{DME,oil}=mass fraction of DME in oleic phase at equilibrium.

Alternatively, to measuring DME concentration via GC and after isolating and disconnecting sapphire cell #2, both aqueous phase and oleic phase could be separated, and then individually taken to a PVT cell at 1 atm and 70° F. After DME evolves from each phase as gas, amounts of evolved DME could be measured and partitioning coefficient calculated.

The results of this analysis are summarized in Table 1 below. As shown in Table 1, the DME partition coefficient ranged from 0.02 to ˜1.3, depending on the salinity of the aqueous phase.

TABLE 1
Partition coefficients measured for DME between an example oil
phase (a volatile light oil or a black light oil) and an aqueous
phase having varying salinity. All tests were performed at room
temperature and >12 hours of equilibration at 150 psi.

| | 0.5% | | | |
|---|---|---|---|---|
| | DME | 0.5% DME + | 1% DME + | 1% DME + |
| Salinity | (Volatile | Methanol | Methanol | Methanol |
| (ppm) | Oil) | (Volatile Oil) | (Volatile Oil) | (Black Oil) |
| 300,000 | 1.26 | — | — | — |
| 150,000 | 1.27 | — | — | — |
| 115,000 | — | 1.13 | 2.4 | 1.87 |
| 103,000 | 1.15 | — | — | — |
| 0 - DI | 0.81 | — | — | — |
| water | | | | |

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

By way of non-limiting illustration, examples of certain embodiments of the present disclosure are given below.

What is claimed is:

1. A method for improving hydrocarbon production from a subterranean formation, the method comprising:
(a) injecting a liquid formulation comprising a miscible solvent into the subterranean formation via a wellbore in fluid communication with the subterranean formation; and
(b) allowing the miscible solvent to partition into hydrocarbons present within the subterranean formation for a period of time;
wherein the subterranean formation has a permeability of less than 0.1 mD.

2. The method of claim 1, wherein the subterranean formation has a permeability of from 1.0×10⁻⁶ mD to less than 0.1 mD.

3. The method of claim 1, wherein the miscible solvent is selected from: dimethyl ether (DME), C₄-C₉ alcohol (e.g., 4-methyl-2-pentanol (also known as methylisobutyl carbinol), hexanol (e.g., n-hexanol), 2-ethylhexanol (e.g., 2-ethyl-1-hexanol), 2-butoxyethanol, benzyl alcohol, sec-butanol, tert-butanol, pentaerythritol, trimethylolpropane), or any combination thereof.

4. The method of claim 1, wherein the miscible solvent is dimethyl ether (DME).

5. The method of claim 4, wherein the miscible solvent is neat dimethyl ether.

6. The method of claim 1, wherein the miscible solvent is injected in an effective amount to reduce the viscosity of the hydrocarbons present within the subterranean formation by from 1% to 90%

7. The method of claim 1, wherein the hydrocarbons present within the subterranean formation comprise light oil.

8. The method of claim 7, wherein the miscible solvent is injected in an effective amount to reduce the viscosity of the light oil present within the subterranean formation by from 20% to 60%.

9. The method of claim 1, wherein the liquid formulation comprising the miscible solvent is injected at a wellhead pressure of from 200 PSI up to 10,000 PSI.

10. The method of claim 1, wherein the method further comprises producing fluids comprising the hydrocarbons from the subterranean formation through the wellbore.

11. The method of claim 10, wherein the method further comprises recovering the miscible solvent from the fluids comprising the hydrocarbons produced from the subterranean formation.

12. The method of claim 11, wherein the method further comprises injecting at least a portion of the recovered the miscible solvent into the subterranean formation via a wellbore in fluid communication with the subterranean formation.

13. The method of claim 1, wherein the liquid formulation comprising the miscible solvent comprises from 1% to 40% by weight of the miscible solvent.

14. The method of claim 13, wherein the liquid formulation comprising the miscible solvent further comprises a non-ionic surfactant, anionic surfactant, or any combination thereof.

15. The method of claim 13, wherein the liquid formulation comprising the miscible solvent further comprises water.

16. The method of claim 1, wherein the method improves the hydrocarbon recovery by at least 10% relative to injection of brine having a TDS of 128,000 ppm.

17. The method of claim 1, wherein the method improves the hydrocarbon recovery by from 10% to 40%, such as 25% relative to injection of brine having a TDS of 128,000 ppm.

18. The method of claim 1, wherein the miscible solvent exhibits a partition coefficient of from 0.01 to 3 with the hydrocarbons present in the subterranean formation.

19. A method for improving hydrocarbon production from a subterranean formation, the method comprising:
(a) injecting a liquid formulation comprising a miscible solvent into the subterranean formation via a wellbore in fluid communication with the subterranean formation; and
(b) allowing the miscible solvent to partition into hydrocarbons present within the subterranean formation for a period of time;
wherein the miscible solvent is injected in an effective amount to reduce the viscosity of the hydrocarbons present within the subterranean formation by at least 1%.

20. A method for improving hydrocarbon production from a subterranean formation, the method comprising:
(a) injecting a volume of a liquid formulation comprising a miscible solvent into the subterranean formation via a wellbore in fluid communication with the subterranean formation; and
(b) allowing the miscible solvent to partition into hydrocarbons present within the subterranean formation for a period of time;
wherein the volume of the liquid formulation comprising a miscible solvent injected into the subterranean formation is determined by the formula below:
$${V}_{o} = \frac{{V}_{o}}{[ \frac{{C}_{i , l}}{{C}_{i , o}} - \frac{1}{k} ]}$$
wherein C_{i,I}=injected concentration of miscible solvent in water; C_{i,w}=equilibrium concentration of miscible solvent in water; C_{i,o}=equilibrium concentration of miscible solvent in water; k=C_{i,o}/C_{i,w}; V_{w}=volume of the liquid formulation comprising the miscible solvent injected into the subterranean formation; and Vₒ=volume of treated hydrocarbon.
